(19) United States
(12) Patent Application Publication
(10) Pub. No.: US 2025/0200583 A1
(43) Pub. Date: Jun. 19, 2025

(54) SYSTEMS AND METHODS FOR PROVIDING A DYNAMIC DEVICE TRUST DASHBOARD

(71) Applicant: Wells Fargo Bank, N.A., San Francisco, CA (US)

(72) Inventors: Matthew N. Wheeler, Charlotte, NC (US); John Andrew Chuprevich, Davidson, NC (US)

(21) Appl. No.: 18/545,484

(22) Filed: Dec. 19, 2023

(51) Int. Cl. G06Q 20/40

(52) U.S. Cl. CPC G06Q 20/409; G06Q 20/4014; G06Q 20/4016

(57) ABSTRACT

Systems, apparatuses, methods, and computer program products are disclosed for providing a device trust dashboard. An example method includes generate a device profile for a first user device associated with a user account of a user. The example method further includes determining a device trust score and an authorization rule set for the first user device and updating the device profile for the first user device. The example method further includes receiving a device trust dashboard request and performing a verification routine for the user. The example method further includes providing the device trust dashboard in an instance the user is successfully verified.

### BACKGROUND

Various institutions may allow users to facilitate user activities or actions for associated user accounts using their user devices. Institutions may monitor user device activities with the user account. However, currently users lack insight into these activities associated with their own user account.

### BRIEF SUMMARY

Institutions have increasingly become reliant on the use of digital technology to facilitate certain user activities or actions. For example, users may use their smartphones to access an associated user account within banking application and perform various activities such as transferring money, reviewing purchases, applying for various credit applications, etc. However, the use of this technology poses a serious security risk to the user if a bad actor were ever able to obtain access to the user's online accounts, such as by using stolen login credentials. Furthermore, with the advent of internet-of-things (IoT) devices, multiple user devices of different types may be linked to a user account. However, users may not frequently monitor or have the ability to easily monitor how the user device is used. Thus, users may lack insight into these various user devices and how they are used to interact with a user account.

While some institutions generate device trust scores that may be indicative of the trustworthiness of a particular user devices, some entities, particularly small entities or entities that lack certain technical expertise, may lack to ability to accurately determine these device trust scores. Furthermore, these device trust scores have been used for internal purposes and are have not been available to the users associated with said user devices. Thus, the user may be unaware of such device trust scores associated with his/her user device and therefore, may not realize the full benefit of such device trust scores.

Accordingly, the present disclosure sets forth systems, methods, and apparatuses that generate and provide a device trust dashboard that allows a user to manage user devices associated with his/her user account. In particular, the device trust dashboard may allow a user to view a device trust score for each of the associated user devices such that the user may be made aware of a current device trust score for a user device. Additionally, the device trust dashboard may allow a user to manage an authorization rule set associated with a particular user device. The authorization rule set may define various permissions, restrictions, requirements, and/or other security protocols for user device. The user device may modify authorization rules of the authorization rule set using the device trust dashboard to allow for tailored management and control of a user device with the user account. Furthermore, the device trust dashboard may allow a user to view what user devices have accessed or have attempted to access the associated user account using a user account access log available on the device trust dashboard, which may include a log of each access event along with event details (e.g., time, date, and location). Thus, a user may be provided with insights into what user devices are interacting with the user account. This may be particularly useful for user devices which are not frequently interacted with by the user but may be linked or have previously been used to interact with the user account, such as smart televisions, smart fridges, smart home assistants, smart cars, and/or other IoT devices. The user account access log may allow a user to identify any strange or anomalous access events such that they may take further action (e.g., change passwords, talk to an institution agent, or the like).

To generate the device trust dashboard, a management device may automatically detect when a user device not currently associated with a device profile successfully accesses a user account or interacts with a user account (e.g., facilitates a transaction) and may generate a new device profile for the user device. A device trust score, device classification, and authorization rule set may be generated for the user device automatically prior to any user input and this device profile may be included in the device trust dashboard, where the user can view this new user device and make modifications if necessary. In some embodiments, a user may set up a user preference set that may be associated with a user account. The user preference set may describe one or more user preferences for the user, such as the user's preferences when granting various permissions, restrictions, requirements, and/or other security protocols for the particular user device and/or device classification. Although no specific to any one deice, this user preference set may be used to establish baseline rules that may be used to generate authorization rules for an authorization rule set for a new user device that are reflective of the user preferences. Thus, this may allow for more tailored authorization rules to be initially generated and reduce the need for modifications, thereby conserving network bandwidth.

Additionally, the device trust dashboard may allow a user to request to improve a device trust score for a device. The device trust score may be used for the authorization rule set for the user device such that an improvement in the device trust score may allow the user device to perform more operations. Additionally, the institution associated with the user account may have various device trust score requirements and may further use the device trust score for other various institutional operations, such as providing a user trust score. Thus, it may be desirable for a user to have the capability to improve a device trust score. While a device trust score for a user device may improve on its own through repeated positive patterns of use, it may be desirable for a device trust score to be more quickly improved, such as when a user replaces a previous user device with a new user device. The user may use the device trust dashboard to provide a device trust improvement request pertaining to a user device of interest. A trust improvement event that optimally achieves the desired device trust score may be generated in response to the request. The trust improvement event may provide one or more operations that require a user to use the user device of interest, thereby strengthening the association of the user with the user device and allowing for an improvement in the device trust score.

The device profile that may be managed by the user via the device trust dashboard may be used when determining whether a user device is authorized to perform a particular device action indicated in a device action request. For example, a device action request may correspond to a transaction request for a particular transaction amount to be performed by a particular user device. The device trust score and authorization rule set for the device profile of the user device may be accessed and used to determine whether the user device is authorized to perform such an action. Additionally, in some embodiments, the user account access log in the device profile may establish a pattern for the user device that may be used to determine whether additional authentication operations are required prior to proceeding with an action flow, even in an instance in which the user device is otherwise authorized to perform the device action.

The device trust dashboard may also provide the user with the ability to perform unique operations to facilitate operations on a user device that the user device may normally not be able to perform. In particular, the user may request a transfer request from a second user device, which may be indicative of a request to temporarily transfer a device trust score of a first user device to the second user device. To facilitate the transfer request, a transfer indicium message may be provided to the first user device, which may display the transfer indicium. The second user device may be required to capture and provide the captured transfer indicium, which may then be verified to ensure it matches the provided transfer indicium. If a match is determined, the value of the device trust score for the second user device may be made equivalent to the value of the device trust score for the first user device for a limited duration. This series of operations is enabled by the device trust dashboard and would ordinarily not be possible. Thus, the device trust dashboard allows for conventionally unavailable interaction between user devices for the benefit of the user.

Additionally, in some embodiments, users may wish to leverage the device profiles managed by the system for use with institutions other than the institution associated with the user account. Thus, users may use their institution user credentials to log into a third-party user account. The institution user credentials may be verified and in an instance in which the user is successfully verified, the third-party institution may be provided with at least a portion of the device profile information of the user device used to perform the log in operation, such as the device trust score associated with this user device. This may additionally aid third-party institutions that lack the capabilities or technology to determine a device trust score by simply providing the device trust score to said third-party institutions that would ordinarily not be available to them. The particular device profile information provided to the third-party institution may be managed within the authentication rule set such that the user may control the particular information provided.

The device profiles associated with the user account of the user may be considered an extension of the user's identity. In some embodiments, the device profiles of user devices associated with the user account may be analyzed and used to generate a user trust score for the user. The user trust score may be indicative of the trustworthiness of the user based on the user's behavior with his/her associated user devices. In some embodiments, third-party entities may be interested in a user trust score in addition to or in lieu of the user device information. For example, a third-party institution that offers services and/or products designed for in person use (e.g., resorts, hotels, car rentals, and/or the like) may wish to have an indication of the trustworthiness of the user and may reward users with high trustworthiness. Thus, users may use their institution user credentials to log into a third-party user account and in an instance in which the user is successfully verified, the user trust score may be provided to the third-party institution. In some embodiments, one or more product offers may additionally be generated for the third-party institution based on the user trust score.

As described above, the device trust dashboard may provide the user with insights into each of the user devices associated with his/her user account and may allow the user to manage his/her user devices using techniques that are not conventionally available. The device trust dashboard may also be used to facilitate various operations that leverage the device profiles for the associated user devices as requested by the user, thereby providing the user with enhanced capabilities for managing and controlling access to his/her user profile and various operations associated with the user profile.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to provide a device trust dashboard.

FIG. 2 illustrates a schematic block diagram of example circuitry embodying a management device of the device management system that may perform various operations in accordance with some example embodiments described herein.

FIG. 3 illustrates a schematic block diagram of example circuitry embodying a user device of the device management system that may perform various operations in accordance with some example embodiments described herein.

FIG. 4 illustrates an example flowchart for generating device profiles for a device trust dashboard, in accordance with some example embodiments described herein.

FIG. 5 illustrates an example flowchart for providing a device trust dashboard, in accordance with some example embodiments described herein.

FIG. 6 illustrates an example flowchart for providing a trust improvement event, in accordance with some example embodiments described herein.

FIG. 7 illustrates an example flowchart for determining a response to a device action request, in accordance with some example embodiments described herein.

FIG. 8 illustrates an example flowchart for performing a transfer indicium routine, in accordance with some example embodiments described herein.

FIG. 9 illustrates an example flowchart for determining a response to a login request received from a third-party device, in accordance with some example embodiments described herein.

FIG. 10 illustrates an example flowchart for determining a response to a user evaluation request received from a third-party device, in accordance with some example embodiments described herein.

FIG. 11 illustrates an example flowchart for providing a device modification request using a user device, in accordance with some example embodiments described herein.

FIG. 12 illustrates an example flowchart for providing a trust improvement event using a user device, in accordance with some example embodiments described herein.

FIG. 13 illustrates a swim lane diagram for generating a device profile for a new user device with example operations that may be performed by components of the environment depicted in FIG. 1, in accordance with some example embodiments described herein.

FIG. 14 illustrates a swim lane diagram for modifying a device profile for a user device with example operations that may be performed by components of the environment depicted in FIG. 1, in accordance with some example embodiments described herein.

FIG. 15 illustrates a swim lane diagram for improving a device trust score with example operations that may be performed by components of the environment depicted in FIG. 1, in accordance with some example embodiments described herein.

FIG. 16 illustrates a swim lane diagram for facilitating a device action request for a user device with example operations that may be performed by components of the environment depicted in FIG. 1, in accordance with some example embodiments described herein.

FIG. 17 illustrates a swim lane diagram for facilitating a transfer indicium routine with example operations that may be performed by components of the environment depicted in FIG. 1, in accordance with some example embodiments described herein.

FIG. 18 illustrates a swim lane diagram for facilitating a device identity request for a third-party device with example operations that may be performed by components of the environment depicted in FIG. 1, in accordance with some example embodiments described herein.

FIG. 19 illustrates a swim lane diagram for facilitating a user evaluation request for a third-party device with example operations that may be performed by components of the environment depicted in FIG. 1, in accordance with some example embodiments described herein.

FIG. 20 illustrates an example user interface depicting an example device trust dashboard as used in some example embodiments described herein.

FIG. 21 illustrates an example user interface depicting an example of a device modification request within a device trust dashboard as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

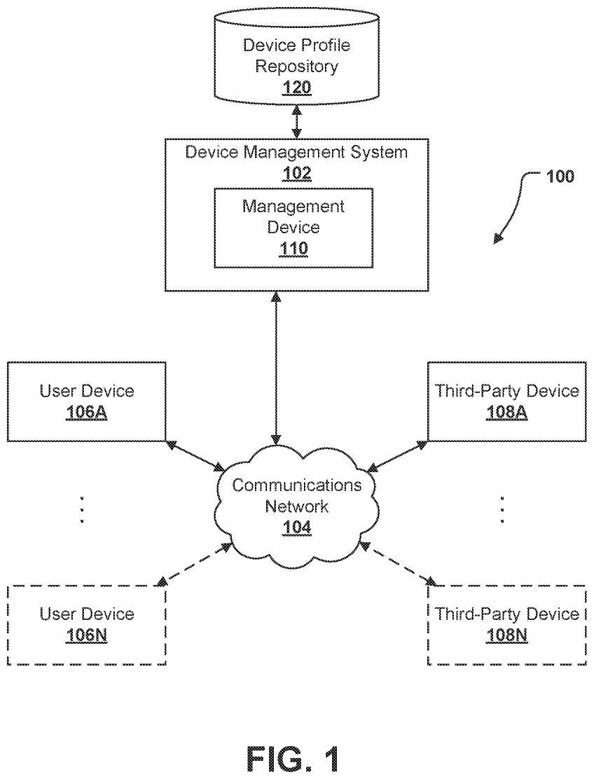

Example embodiments described herein may be implemented using any of a variety of computing devices or servers. To this end, FIG. 1 illustrates an example environment 100 within which various embodiments may operate. As illustrated, a device management system 102 may receive and/or transmit information via communications network 104 (e.g., the Internet) with any number of other devices, such as one or more of user devices 106A-106N and/or third-party devices 108A-108N.

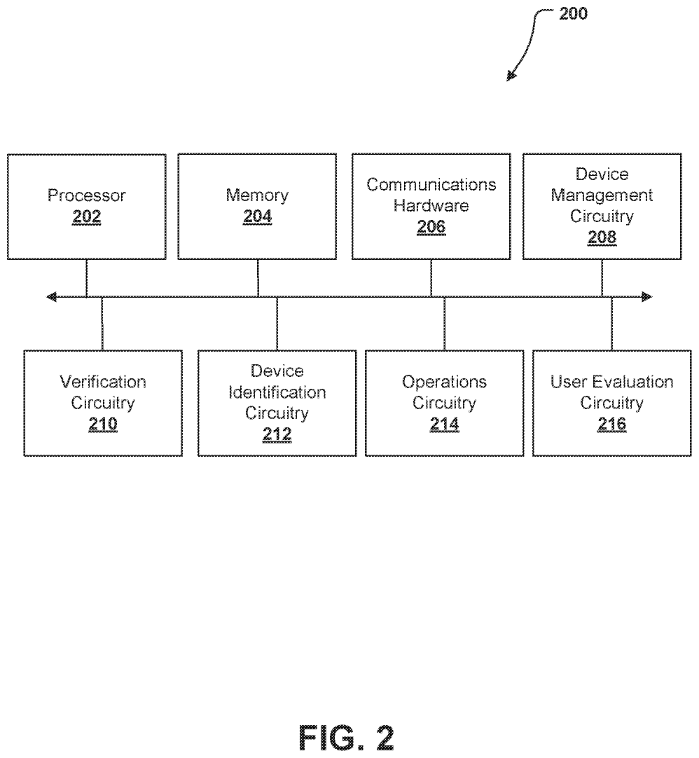

The device management system 102 may be implemented as one or more computing devices or servers, which may be composed of a series of components. Particular components of the device management system 102 are described in greater detail below with reference to apparatus 200 in connection with FIG. 2. In some embodiments, the device management system 102 includes a management device 110.

In some embodiments, the device management system 102 may further includes device profile repository 120 that comprises a distinct component from other components of the device management system 102. The device profile repository 120 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The device profile repository 120 may host the software executed to operate the device management system 102. The storage device may store information relied upon during operation of the device management system 102, such as various device profiles, user accounts, and/or information, software executable code of various models, computer readable instructions for various processes that may be used by the device management system 102, data and documents to be analyzed using the device management system 102, or the like. In addition, the device profile repository 120 may store control signals, device characteristics, and access credentials enabling interaction between the device management system 102 and one or more of the user devices 106A-106N or third-party devices 108A-108N.

The one or more user devices 106A-106N and the one or more third-party devices 108A-108N may be embodied by any computing devices known in the art. The one or more user devices 106A-106N and the one or more third-party devices 108A-108N need not themselves be independent devices, but may be peripheral devices communicatively coupled to other computing devices.

Although FIG. 1 illustrates an environment and implementation in which the device management system 102 interacts indirectly with a user via one or more of user device 106A-106N and/or third-party device 108A-108N, in some embodiments users may directly interact with the device management system 102 (e.g., via communications hardware of the device management system 102 and/or management device 110), in which case a separate user device 106A-106N and/or third-party device 108A-108N may not be utilized. Whether by way of direct interaction or indirect interaction via another device, a user may communicate with, operate, control, modify, or otherwise interact with the device management system 102 to perform the various functions and achieve the various benefits described herein.

### Example Management Device

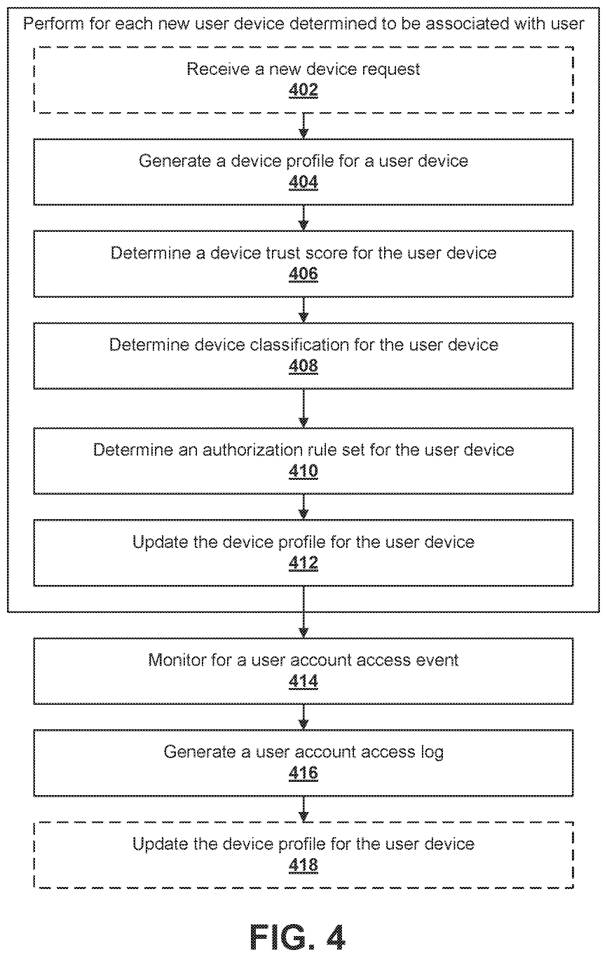

The management device 110 of device management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-10. As illustrated in FIG. 2, the apparatus 200 may include processor 202, memory 204, communications hardware 206, device management circuitry 208, verification circuitry 210, device identification circuitry 212, operations circuitry 214, and/or user evaluation circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In some embodiments, the communication hardware 206 may be configured to receive candidate user credentials, provide a device trust dashboard, provide a trust improvement event, provide a one-time passcode, receive a one-time passcode, provide a selfie request, receive a selfie response, receive a device modification request, receive a device action request, provide denial responses, receive a new device request, receive a transfer request, provide a transfer indicium message, receive a candidate captured transfer indicium, receive a device identity request, provide a device identity confirmation response, receive a user evaluation request, provide a user evaluation response, and/or the like. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated user device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a device management circuitry 208 that may be configured to generate a device profile, determine a device trust score, determine an authorization rule set, determine a device classification, update a device profile, generate a trust improvement event, detect performance of a trust improvement event, update a device trust score, identify device profiles, and/or the like. The device management circuitry 208 may utilize processor 202, memory 204, or any other hardware component included in the apparatus 200 to perform these operations, as described in connection with FIGS. 4-10 below. The device management circuitry 208 may further utilize communications hardware 206 to gather data from a variety of sources (e.g., user device 106A-106N, third-party device 108A-108N, device profile repository 120, as shown in FIG. 1), and/or exchange data with a user.

In addition, the apparatus 200 further comprises a verification circuitry 210 that may be configured to perform a verification routine for a user, perform a transfer indicium routine, and/or the like. The verification circuitry 210 may utilize processor 202, memory 204, or any other hardware component included in the apparatus 200 to perform these operations, as described in connection with FIGS. 4-10 below. The verification circuitry 210 may further utilize communications hardware 206 to gather data from a variety of sources (e.g., user device 106A-106N, third-party device 108A-108N, device profile repository 120, as shown in FIG. 1), and/or exchange data with a user.

In addition, the apparatus 200 further comprises a device identification circuitry 212 that may be configured to monitor for a user account access event, generate a user account access log, and/or the like. The device identification circuitry 212 may utilize processor 202, memory 204, or any other hardware component included in the apparatus 200 to perform these operations, as described in connection with FIGS. 4-10 below. The device identification circuitry 212 may further utilize communications hardware 206 to gather data from a variety of sources (e.g., user device 106A-106N, third-party device 108A-108N, device profile repository 120, as shown in FIG. 1), and/or exchange data with a user.

In addition, the apparatus 200 further comprises an operations circuitry 214 that may be configured to identify a device profile, determine whether a user device is authorized to perform a device action request, perform an action flow, and/or the like. The operations circuitry 214 may utilize processor 202, memory 204, or any other hardware component included in the apparatus 200 to perform these operations, as described in connection with FIGS. 4-10 below. The operations circuitry 214 may further utilize communications hardware 206 to gather data from a variety of sources (e.g., user device 106A-106N, third-party device 108A-108N, device profile repository 120, as shown in FIG. 1), and/or exchange data with a user.

In addition, the apparatus 200 further comprises a user evaluation circuitry 216 that may be configured to generate a user trust score, generate one or more product offers, and/or the like. The user evaluation circuitry 216 may utilize processor 202, memory 204, or any other hardware component included in the apparatus 200 to perform these operations, as described in connection with FIGS. 4-10 below. The user evaluation circuitry 216 may further utilize communications hardware 206 to gather data from a variety of sources (e.g., user device 106A-106N, third-party device 108A-108N, device profile repository 120, as shown in FIG. 1), and/or exchange data with a user.

Although components 202-216 are described in part using functional language, it will be understood that the particular implementations necessarily include the use of particular hardware. It should also be understood that certain of these components 202-216 may include similar or common hardware. For example, the device management circuitry 208, verification circuitry 210, device identification circuitry 212, operations circuitry 214, and user evaluation circuitry 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the device management circuitry 208, verification circuitry 210, device identification circuitry 212, operations circuitry 214, and user evaluation circuitry 216 may leverage processor 202, memory 204, or communications hardware 206 as described above, it will be understood that any of device management circuitry 208, verification circuitry 210, device identification circuitry 212, operations circuitry 214, and user evaluation circuitry 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that device management circuitry 208, verification circuitry 210, device identification circuitry 212, operations circuitry 214, and user evaluation circuitry 216 comprise particular machinery designed for performing the functions described herein in connection with such elements of apparatus 200.

### Example User Device

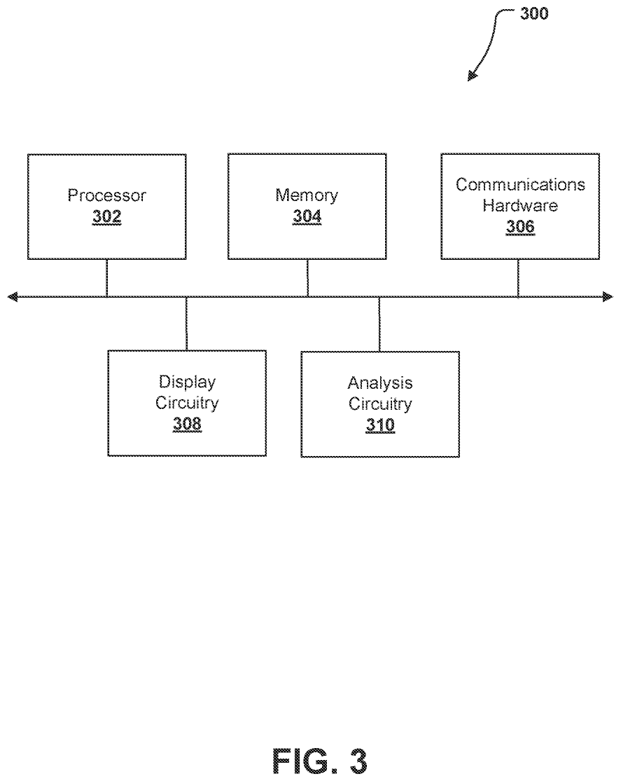

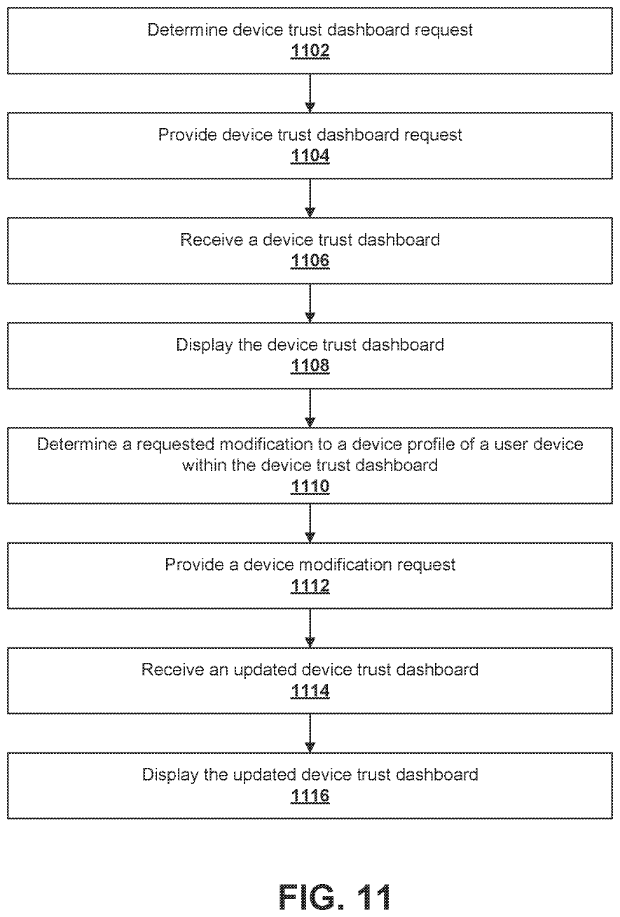

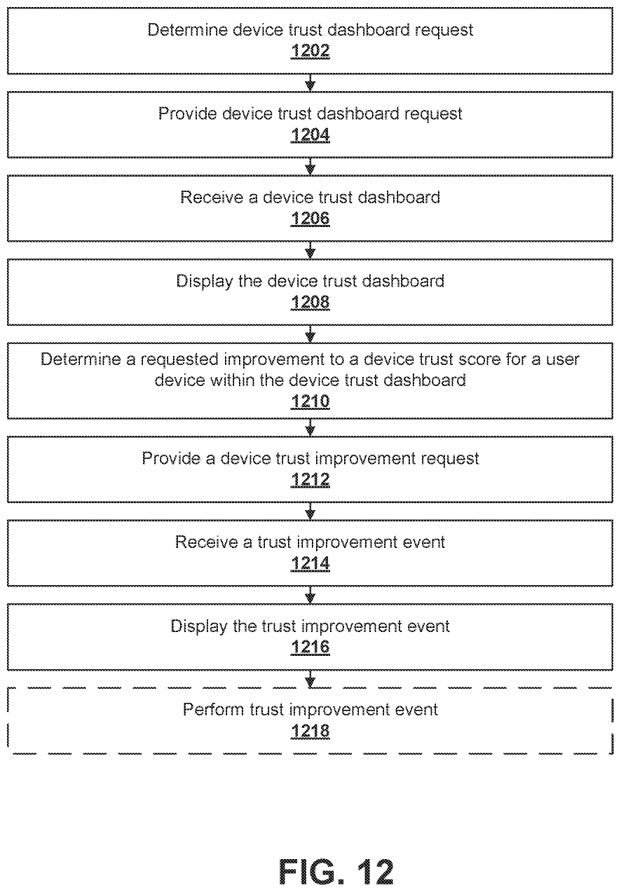

As illustrated in FIG. 3, an apparatus 300 is shown that represents an example user device (e.g., any of user device 106A-106N). The apparatus 300 includes processor 302, memory 304, and communications hardware 306, each of which is configured to be similar to the similarly named components described above in connection with FIG. 2. Apparatus 300 may further include display circuitry 308 and analysis circuitry 310. The display circuitry 308 may be configured to render display of a device display dashboard, received transfer indicium, and/or the like. The display circuitry 308 may utilize processor 302, memory 304, communications hardware 306, or any other hardware component included in the apparatus 300 to perform these operations, as described in connection with FIGS. 11-12 below. The analysis circuitry 310 may be configured to determine a requested modification, determine a request improvement to a device trust score, and/or the like. The analysis circuitry 310 may utilize processor 302, memory 304, communications hardware 306, or any other hardware component included in the apparatus 300 to perform these operations, as described in connection with FIGS. 11-12 below.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Management Device Operations

Turning to FIGS. 4-10, example flowcharts are illustrated that contain example operations implemented by example embodiments described herein. The operations illustrated in FIGS. 4-10 may, for example, be performed by management device 110 of the device management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, device management circuitry 208, verification circuitry 210, device identification circuitry 212, operations circuitry 214, user evaluation circuitry 216, and/or any combination thereof. It will be understood that user interaction with the management device 110 may occur directly via communications hardware 206, or may instead be facilitated by a separate device (not shown in FIG. 1), which may have similar or equivalent physical componentry facilitating such user interaction.

Additionally, for the purposes of clarity, the operations described below may refer to a particular user device and/or third-party device, such as user device 106A or third-party device 108A. However, it will be appreciated that any one of user devices 106A-106N may be a user device or any one of third-party devices 108A-108N may be used as a third-party device, unless explicitly stated otherwise.

### Device Trust Dashboard Management

Turning first to FIG. 4, example operations are shown for generating device profiles for a device trust dashboard. The device trust dashboard may provide a user with various device information for each user device determined to be associated with a user account of the user. Device information for a user device may be included in device profile for the user device. For example, the device profile may include a device trust score, a device classification, an authorization rule set, a user account access event for the user device, and/or the like.

In some embodiments, operations 402-412 may be performed for each new user device that is determined to be associated with a user of interest. As described in further detail further below, a user device may be determined to be associated with a user in an instance in which the user device is used to successfully access a user account associated with the user. Alternatively, a user may use his/her device trust dashboard and request to add a new user device to his/her device trust dashboard. Regardless of the mechanism used to determine a user device is associated with the user, the apparatus 200 may determine that the user device does not currently have a user device profile associated with the user account of the user and thus, is not currently associated with the user. Therefore, the apparatus 200 may determine to generate a new device profile for the user device and perform the operations of 402-412. The apparatus 200 may perform these operations for each new user device determined to be associated with the user. Said otherwise, the apparatus 200 may perform operations 402-412 to generate device profiles for any number of user devices determined to be associated with the user. Thus, the device trust dashboard may reflect an accurate and complete picture of the user devices associated with the user.

Optionally, as shown by operation 402, the apparatus 200 includes means, such as processor 202, memory 204, communications hardware 206, or the like, for receiving a new device request. In some embodiments, the communications hardware 206 may receive a new device request from a user via a device trust dashboard through user device 106A. The device trust dashboard may be a user interface tool that is accessible to users affiliated with a particular entity associated with said device trust dashboard. As discussed in greater detail below, the device trust dashboard may provide an authenticated user to manage, monitor, analyze, view, etc. various metrics about user devices associated with the user account corresponding to the user. A user may access to the device trust dashboard via a user device (e.g., any one of user devices 106A-106N) by providing his/her user credentials (e.g., username, password, personal identification number (PIN), biometric, and/or the like) that are associated with the corresponding account. By way of particular example, apparatus 200 may be associated with a financial institution where a user may have one or more user accounts (e.g., checking, savings, loans, and/or the like). The user may use a user device to log into his/her account via a user device and navigate to the device trust dashboard in order to access the device trust dashboard. Alternatively, the user may directly log into the device trust dashboard via the user device by providing his/her credentials to a specific device trust dashboard uniform resource location (URL) address or software application configured to automatically direct the user to the device trust dashboard (e.g., no additional navigation required).

Once a user has successfully accessed the device trust dashboard via user device 106A, the user may select (e.g., click, touch, audibly select, or the like) an option within the device trust dashboard to add a new user device. This selection may automatically trigger the device trust dashboard to provide a new device request to the communications hardware 206. The new device request may further include device information for the user device to be associated with the user account. The device information may include one or more device identifiers (e.g., an international mobile equipment identity (IMEI), a media access control (MAC) address, a serial number, an electronic serial number (ESN), a mobile equipment identifier (MEI), a unique device identifier (UDID), a globally unique identifier (GUID), a radio-frequency identification (RFID) tag, a smart vehicle identification number (VIN), or the like) such that the user device may be uniquely identified. The device information may further include information on the type of device (e.g., cell phone, tablet, smart watch, smart wearable, smart car, smart television, smart fridge, smart home assistants, IoT devices, or other devices capable of accessing the user account), device model, software version running on device, associated phone numbers (if applicable), current device permissions, or the like.

In some embodiments, user device 106A used to access the device trust dashboard is the device to which the new device request pertains to. In such an embodiment, the new device request may automatically be populated using the user device information. Alternatively, the new device request may be associated with a different user device such that the user may be required to manually input at least a portion of the device information. In some embodiments, a minimal amount of device information is needed manually from the user. Once the communications hardware 206 receives the new device request, a device management circuitry 208 may be configured to evaluate whether additional device information is needed for user device. In some embodiments, in an instance in which additional device information is needed, the device management circuitry 208 may generate a device information request and use the communications hardware 206 to provide the device information request to the corresponding user device. The device information request may be indicative of a request from apparatus 200 for the user device to provide additional device information to communications hardware such that at least a portion of the missing device information may be completed. The recipient user device, if so authorized by the user, may provide a device information response to communications hardware 206, which may include at least a portion of the missing device information. The device management circuitry 208 may then update the new device request to include the missing device information.

In some embodiments, the new device request may further include an indication of a device classification for the user device. A device classification may be indicative of a category of the user device and may establish a relationship between the particular user device and the user. For example, a device classification may include a primary user device, a personal user device, a work user device, a shared user device, a limited access device, or the like. By way of particular example, a primary user device classification may be indicative that the user device is the user's primary and/or preferred user device whereas a work device classification is indicative that the user device is associated with the user but is a work phone. As described in further detail below, the authorization rule set may set rules for different device classifications such that individual user devices associated with the user may experience various security or trust treatment. A user device may be associated with one or more device classifications.

In some embodiments, the new device request may further include an indication of one or more authorization rules. Particularly for new device requests associated with a user device with a new device classification, the authorization rules may describe rules that define certain permissions, restrictions, requirements, and/or other security protocols for the particular user device. As described in more detail below, the one or more authorization rules may define permissions for the user device/device classification for accessing the user account, permissions of the user device/device classification for performing actions associated with the user account, permissions of the user device/device classification for accessing another user account, a transaction limit for the user device/device classification, a type of user credential required to perform certain actions via the user device/device classification, and/or the like.

In an instance in which the communications hardware 206 receives a new device request from a user device via the device trust dashboard, this may trigger the device management circuitry 208 to perform operations 404-412 as described in greater detail below. By doing so, the device management circuitry 208 may generate a device profile for the requested user device and associated the device profile with the user account. As such, the user may access a device trust dashboard to view the device profile for the user device such that the user may manage the user device via the device trust dashboard.

As shown by operation 404, the apparatus 200 includes means, such as processor 202, memory 204, device management circuitry 208, device identification circuitry 212, or the like, for generating a device profile for user device 106A. In some embodiments, the device management circuitry 208 may determine to generate a device profile for user device 106A in response to receiving a new device request, as described above in operation 402. In some embodiments, the device management circuitry 208 may receive an indication from device identification circuitry 212 that user device 106A has been used to successfully log into a user account of the user. The device management circuitry 208 may be configured to determine whether user device 106A that accessed the user account is currently associated with a device profile. The device management circuitry 208 may be configured to generate a device profile for user device 106A in an instance in which no corresponding device profile for user device 106A is currently associated with the user account. In some embodiments, the device management circuitry 208 may be configured to store the device profile for user device 106A in the device profile repository 120.

The device management circuitry 208 may access the device profile repository 120, which may be configured to securely store device profiles associated with a user account and in some embodiments, a user account. In some embodiments, the device profile repository 120 may store user accounts and one or more associated device profiles for each user account. Alternatively, the device profile repository 120 may be configured to store the device profiles and the user accounts may be stored in a separate storage. In such an instance, the device profiles may be linked to a particular user account such that the devices profiles are still associated with the user account.

The device management circuitry 208 may compare the device identifier obtained from user device 106A that accessed the user account with device identifiers included in device profiles associated with the user. By way of particular example, the device management circuitry 208 may compare an IMEI, a MAC address, a serial number, an ESN, a MEI, a UDID, a GUID, a RFID tag, a smart VIN, or the like, of user device 106A with device identifiers included in device profiles associated with the user account. In an instance in which no matching device identifier is found within any device profile associated with the user account, the device management circuitry 208 may generate a new device profile for user device 106A. In an instance in which a matching device identifier is found within a device profile associated with the user, the device management circuitry 208 may skip to operation 418.

A device profile may pertain to a user device determined to be associated with a user account for the user. In some embodiments, the device profile may be stored in the device profile repository 120, or within a memory, such as memory 204. A device profile may be uniquely identified using the one or more device identifiers that correspond to the user device. In some embodiments, the device profile may further include device information and other information that is associated with the user device. For example, the device profile may include the one or more device identifiers, the type of device (e.g., cell phone, tablet, smart watch, smart wearable, smart car, smart television, smart fridge, smart home assistants, IoT devices, or other devices capable of accessing the user account), a device model, a software version running on device, associated phone numbers (if applicable), current device permissions, or the like. Additionally, a device profile may include access log information for the user device and/or associated action log for the user device. The access log information may be indicative of a time, date, and geographic location of when the user device was used to directly access a user account. The associated action log may be indicative of a requested actions received from the user device. In some embodiments, the device management circuitry 208 may generate the device profile with device information that was included in the new device request and/or is readily available or accessible from the detection of the user device's access to the user account. For example, the device management circuitry 208 may obtain a device identifier, type of device, phone number, a device model, software version, or the like, of user device 106A that accessed the user account. The device information provided by the user device may be dependent upon the type of user device and/or the type of access event (e.g., via a mobile application, via a web application, indirectly through a transaction involving the user account, or the like). In some embodiments, the device management circuitry 208 may be configured to receive an indication of when a user device interacts with the user account to facilitate a transaction. For example, the user device may be used to facilitate an online purchase using a card number that is associated with a user account. Thus, the user device may not directly log into the user account but may be used to facilitate the transaction using the card number associated with the user account.

Additionally, the device profile may be associated with a device trust score, an authorization rule set, and device classification. The device management circuitry 208 may generate the device profile for the user device such that the values for various fields (e.g., device trust score, authorization rule set, device classification, and/or other device information not readily provided) are initially set to a default value. The device management circuitry 208 may perform operations 406-412 to determine these values and update the device profile for user device 106A.

As shown by operation 406, the apparatus 200 includes means, such as processor 202, memory 204, device management circuitry 208, or the like, for determining a device trust score for user device 106A. Once the device management circuitry 208 has generate the device profile for user device 106A, the device management circuitry 208 may determine a device trust score for user device 106A. A device trust score may be a value indicative of an inferred amount of trustworthiness or security of user device 106A. In some embodiments, the device trust score is a numerical value within a define trust score range. For example, a defined trust score range may be defined between a trust score value of 0, indicative of a user device known to be untrustworthy (e.g., stolen, associated with a fraudster, or the like), and a trust score value of 10, indicative of a user device known to be trustworthy.

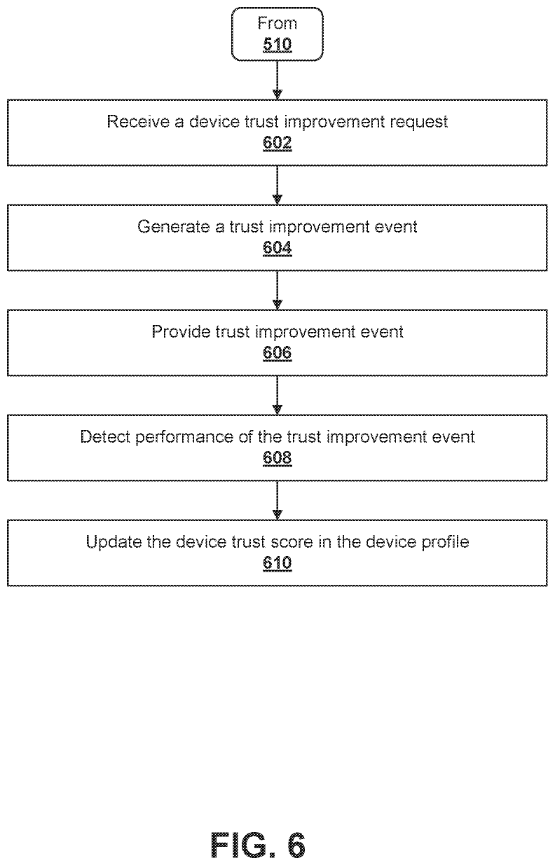

In some embodiments, the institution associated with the user account may have various device trust score requirements and may further use the device trust score for other various institutional operations, such as providing a user trust score. Additionally, the device trust score may be used when determining authorization rules for the authorization rule set for the user device, as described in further detail in operation 410. In contrast to the device classification and authorization rule set for the user device, as described in further detail in operations 406 and 408, respectively, the device trust score for the user device is not directly modifiable by the user. Although performance of a device trust improvement event may expedite improvement of a device trust score as described in FIG. 6, the device trust score itself is not directly modifiable by the user. This helps maintain the security of the user account and mitigates security risks posed by a fraudster who gains access to a user account using a non-authentic user device.

The device management circuitry 207 may determine a device trust score based on a device feature set associated with user device 106A. In some embodiments, the device management circuitry 208 may use a pre-processing model to generate the device feature set for user device 106A. The device feature set may include one or more device features of user device 106A and each device feature may be structured for further processing. In some embodiments, a device feature corresponds to a particular device information data value for the device information included in the device profile. For example, a device profile may include the type of device, which may correspond to a device information data value of “cell phone”. The pre-processing model may transform the device information data value of “cell phone” into a numerical format that may be more easily processed. In some embodiments, the pre-processing model uses one-hot encoding to transform categorical device information data values into a numerical data. By way of continuing example, the pre-processing model may transform the device information data value of “cell phone” into a one-hot encoded value of [1, 0, 0, . . . 0], where the value of 1 corresponds to a cell phone device type and the values of 0 each correspond to a different device type (e.g., tablet, smart watch, smart wearable, smart car, smart television, smart fridge, smart home assistant, IoT device, or miscellaneous device). Additionally, or alternatively, the pre-processing model may use vectorization to transform text data into numerical vectors using various methods, such as bag-of-words, term frequency-inverse document frequency, word2vec, GloVe, and/or the like. Thus, the pre-processing model may be used to transform current device information for user device 106A into structured, device features to aid with subsequent processing.

In some embodiments, the device management circuitry 208 may determine a device trust score for user device 106A using a device trust scoring model. The device trust scoring model may be a trained machine learning model configured to process a device feature set for a user device and determine a device trust score for the user device based on the device feature set. In some embodiments, the device trust scoring model is a deep learning model, such as a neural network (e.g., a convolutional neural network (CNN) or recurrent neural network (RNN)) trained using a trust score training data set. In some embodiments, the device trust scoring model may additionally implement anomaly detection techniques. The trust score training data set may include a plurality of device feature sets, each corresponding to a user device, that are labelled with an indication of whether the user device was involved in a fraudulent use (e.g., user device was stolen, user device was used to fraudulently access a user account, user device was used for a fraudulent purchase, and/or the like). Thus, the device trust scoring model may be configured to identify patterns, anomalies, or other outliers within the device feature set that are inferred to be correlated with untrustworthiness and/or trustworthiness.

The device management circuitry 208 may provide a device profile to a pre-processing model, which may be configured to extract the device profile information and generate a device feature set that includes one or more device features. The pre-processing model may then be configured to provide the device feature set to the device trust scoring model, which may process the device feature set to determine a device trust score for user device 106A. The device trust scoring model may output the device trust score to the device management circuitry 208.

As shown by operation 408, the apparatus 200 includes means, such as processor 202, memory 204, device management circuitry 208, or the like, for determining a device classification for user device 106A. In some embodiments, such as in an instance in which a new device request is received, a user may provide an indication of the device classification for a user device. The device management circuitry 208 may then automatically determine the device classification for user device 106A based on the indication provided by the user. For example, a user may provide a new device request and may input a device classification selection. Thus, the device management circuitry 208 may determine the device classification of user device 106A to be the device classification provided in the new device request.

In some embodiments, the device management circuitry 208 may be configured to use a device classification inference model to determine the device classification for user device 106A. The device classification inference model may be a rules-based model or machine-learning model configured to determine the device classification based on associated device information and/or other user device profiles associated with the user. In some embodiments, the device classification inference model may be configured to determine whether the device identifier of user device 106A is associated with one or more other user accounts. In an instance in which the device identifier is associated with another user account that does not correspond to the user, the device classification inference model may be configured to infer user device 106A is not only associated with the user and therefore, may determine a device classification of a limited access device and/or a shared user device. As another example, the device classification inference model may determine the device identifier is only associated with the user but the user account has one or more other device profiles (e.g., one or more other user devices) which may have a device classification. In an instance in which a primary user device classification is associated with one of the other user devices, the device classification inference model may determine a device classification of a personal user device. In general, only one user device is associated with a device classification of primary user device, which may be indicative of the user device that is the user's default for accessing and/or performing actions associated with the user account

In some embodiments, the device classification inference model may determine the device classification based on the device type associated with user device 106A. For example, if the device is a smart television, smart fridge, smart home assistant, IoT device, or other device that is commonly shared within a household, the device classification inference model may determine a shared device, device classification. Alternatively, if user device 106A is a cell phone, a smart watch, or a smart wearable, the device classification inference model may determine a personal device, device classification.

As described in more detail in operation 418, in some embodiments, the access log for user device 106A may be used by the device classification inference model to determine a device classification. The access log for user device 106A may provide information regarding the times user device 106A accesses the user account. In some embodiments, the device classification inference model may use patterns of the time of access for user device 106A to update a device classification for user device 106A. For example, in an instance in which the user device is only used to access the user account between the hours of 9 am and 5 pm on weekdays, the device classification inference model may determine a device classification of a work device for user device 106A. However, during the initial device profile generation, access log information may not currently be available and thus, the device classification inference model may be unable to determine more granular device classifications until such information is available.

As shown by operation 410, the apparatus 200 includes means, such as processor 202, memory 204, device management circuitry 208, or the like, for determining an authorization rule set for user device 106A. An authorization rule set may include one or more authorization rules that may define various permissions, restrictions, requirements, and/or other security protocols for user device 106A. In particular, an authorization rule may define permissions for user device 106A and/or a device classification for accessing the user account, permissions of user device 106 and/or a device classification for performing actions associated with the user account, permissions of user device 106A and/or device classification for accessing another user account, a transaction limit for user device 106A and/or device classification, a type of user credential required to perform certain actions via user device 106A and/or device classification, and/or the like. Thus, the authorization rule set associated with the user profile for user device 106A may define permissions, restrictions, requirements, and/or other security protocols necessary for user device 106A to perform certain actions/operations. In some embodiments, the device management circuitry 208 may determine the authorization rule set for user device 106A based on the device trust score and/or a user preference set.

A user preference set may be associated with a user account of the user and may describe one or more user preferences for the user. The one or more user preferences may be indicative of a user's preferences when granting various permissions, restrictions, requirements, and/or other security protocols for the particular user device and/or device classification. In particular, user preferences may define requested permissions for user device 106A and/or a device classification for accessing the user account, requested permissions of user device 106A and/or device classification for performing actions associated with the user account, requested permissions of user device 106A and/or device classification for accessing another user account, a requested transaction limit for user device 106A and/or device classification, a requested type of user credential required to perform certain actions via user device 106A and/or a device classification, and/or the like. For example, the user preference set for a user may include a user preference indicative of a maximum transaction limit of $1000, a user preference indicative of a maximum transaction limit of 3 transactions per day, a user preference indicative of a requirement for a biometric credential to be required for a maximum trust score, a user preference indicative of device classifications of a shared device and/or limited access device to have a device trust score cap or maximum of 7, a user preference indicative that only the associated user is authorized to perform transactions, and a user preference indicative that limited access users may have viewing permissions. Thus, the device management circuitry 208 may use these user preferences when determining the authorization rule set for a user device, such as user device 106A.

In some embodiments, the user account may designate a limited user associated with the user. A limited user may be a user trusted by the user of interest and who is granted with certain limited permissions and/or access to the user account. For example, a limited user may be a spouse, child, parent, sibling, relative, trusted friend, beneficiary, etc. of the user. By designating a trusted individual as a limited user associated with the user account, the limited user may be able to assist the user with various user account operations and management techniques in a limited capacity such that the user account remains secure. The user preference set may be indicative of these limited users.

When generating the authorization rule set for user device 106A, the device management circuitry 208 may add limited users as a designated authorized user for the device profile. In some embodiments, the device management circuitry 208 may evaluate whether the device profile satisfies certain criteria prior to adding the limited user to the device profile. The user preference set may describe criteria the user device or device profile must satisfy in order for a limited user to be added as a limited user to the device profile. For example, the user preference set may describe that a limited user be added to any device profile associated with the user account except for a user device associated with a work device classification. Thus, the device management circuitry 208 may determine to add the limited user to the device profile for user device 106A in an instance in which user device 106A is not associated with a work device classification.

In some embodiments, a limited user may be associated with his/her own user account and have separate user account credentials. In such an instance, the device management circuitry 208 may link the limited user within the device profile with the corresponding user account for the limited user. This linked user account may be used in an instance in which a limited user needs to be verified in addition to or in lieu of the user associated with user device 106A.

In some embodiments, the limited user may not be associated with his/her own user account. In such an instance, when the user is configuring his/her user preference set, the limited user may be required to setup his/her own user credentials which are separate from the user's account credentials. However, the limited user's user credentials may be stored within the user account of the user of interest such that the limited user may still be verified prior to accessing the user account.

The device management circuitry 208 may determine the one or more rules based on the device trust score associated with user device 106A, as determined in operation 406. For example, the device management circuitry 208 may determine certain permissions, restrictions, requirements, etc. for user device 106A based on the current device trust score. By way of particular example, the user preference set associated with the user may be indicative that only user devices associated with a device trust score of 7 or greater are capable of performing transactions. Thus, the device management circuitry 208 may determine whether user device 106A may perform transactions based on the user preference set.

In some embodiments, the device management circuitry 208 may use an authorization rule determination model to determine the authorization rule set for user device 106A. The authorization rule determination model may be a rules-based model, such as a decision tree, configured to receive the user preference set and device trust score, and in some embodiments, device information, to determine the one or more authorization rules for the authorization rule set. The authorization rule determination model may be configured to apply mathematical and/or logical operations to the user preference set, device trust score, and/or device information to perform comparisons and determine one or more authorization rules.

As shown by operation 412, the apparatus 200 includes means, such as processor 202, memory 204, device management circuitry 208, or the like, for updating the device profile for user device 106A. Once the device management circuitry 208 has determined a device trust score, an authorization rule set, and a device classification for user device 106A, the device management circuitry 208 may update the device profile to reflect these determinations. In particular, the device management circuitry 208 may replace a default device trust score value with the device trust score value determined in operation 406, a default authorization rule set for with the authorization rule set determined in operation 410, and a default device classification with the device classification determined in operation 408. As such, the device profile for user device 106A may be updated to reflect up-to-date and accurate information for user device 106A. In an instance in which the device profile is stored within the device profile repository 120, the device management circuitry 208 may access the stored device profile to modify the values of the device profile. Thus, the stored device profile may be updated for user device 106A.

As shown by operation 414, the apparatus 200 includes means, such as processor 202, memory 204, device identification circuitry 212, or the like, for monitoring for a user account access event. The device identification circuitry 212 may monitor the user account associated with the user for any access attempt (e.g., successful or unsuccessful). The device identification circuitry 212 may be configured to detect any attempted or successful access of a user account by user device 106A and may capture at least a time, date, and geographic location of the access attempt.

As shown by operation 416, the apparatus 200 includes means, such as processor 202, memory 204, device identification circuitry 212, or the like, for generating a user account access log. The device identification circuitry 212 may capture at least a time, date, and geographic location of the access attempt and may generate and/or update a user account access log with this access attempt. The device identification circuitry 212 may also be configured to categorize the attempt as a successful attempt or unsuccessful attempt. In some embodiments, the access attempt may further include a device identifier indicative of the user device associated with the access attempt. Thus, the user account access log may be indicative of which user devices were associated with attempting to access the user account as well as event details (e.g., time, date, and location). In some embodiments, the event details may further include a digital signature of the user device, which may be indicative of the user devices connected to the user device. For example, if the user device is an IoT device, the user device may be connected to other IoT user devices, which may each have a unique user identifier. These user identifiers of user devices connected to the user device may be included in the digital signature. The user account access log may therefore provide a user with an overview of various metrics on user devices accessing their corresponding user accounts such that the users may be provided with a clearer picture of how their user accounts are being accessed.

Optionally, as shown by operation 418, the apparatus 200 includes means, such as processor 202, memory 204, device management circuitry 208, device identification circuitry 212, or the like, for updating a device profile for the user device. The device identification circuitry 212 may generate and/or update a user account access log for the user account associated with a user. The device management circuitry 208 may also be configured to process this user account access log, identify whether a user device is associated with a device profile, and update the device profile based on the user account access long. In an instance in which the device profile is stored within the device profile repository 120, the device management circuitry 208 may access the stored device profile to update the device profile.

In some embodiments, the device management circuitry 208 may be configured to update the device profile to reflect the access event for the corresponding user device. For example, if a user account access log describes that a user identifier corresponding to user device 106A was used to successfully access a user account on Nov. 1, 2023 at 11:00 am in Charlotte, North Carolina, the device management circuitry 208 may identify the device profile of user device 106A and update the device profile to reflect that the device successfully accessed the user account on Nov. 1, 2023 at 11:00 am.

As described above, in some embodiments, the device management circuitry 208 may provide the user account access log and/or access events associated with a device profile to a device classification inference model that may use patterns of the time of access for the user device to update a device classification for the user device. The device classification inference model may use this information to update a device classification for the user device. For example, in an instance in which the user device is only used to access the user account between the hours of 9 am and 5 pm on weekdays, the device classification inference model may determine a device classification of a work device for the user device.

Additionally, the user account access log of a particular device profile may provide a user device pattern that may be used to help authenticate the user device. The user account access log may provide insights into geographical, temporal, or digital signal patterns that may be used to help authenticate a particular user device or for other purposes. For example, a user device may typically be associated with 3 unique device identifiers as indicated by the digital signature of the user device and may typically access a user account at a particular geographic location. In an instance in which the user device is used to log into a user account but the digital signature does not indicate any of the typical 3 unique device identifiers and/or the user account is accessed at a geographic location that is not nearby the particular geographic location, this may be indicative that the device has been stolen and additional authentication operations should be performed to confirm user identity prior to allowing the user device to access the user account.

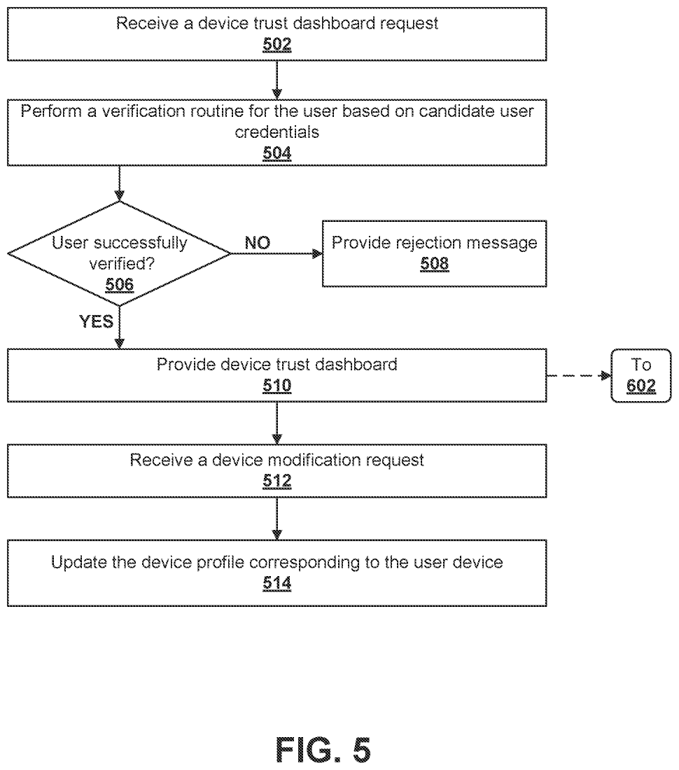

Turning now to FIG. 5, example operations are shown for providing a device trust dashboard to a user. The device trust dashboard may allow a user to manage user devices associated with his/her user account. In particular, the device trust dashboard may be generated for a user based on the device profiles for each user device associated with the user account. The device trust dashboard may allow a user to view a device trust score for each of the associated user devices, manage an authorization rule set for each of the associated user devices, view an account access log that includes a log of each access event along with event details (e.g., time, date, and location), and/or the like. Thus, the device trust dashboard may provide a user with insights into what user devices are interacting with his/her user account and the manner of the interaction and further, may allow the user to control various parameters and permissions for the user device.

As shown by operation 502, the apparatus 200 includes means, such as processor 202, memory 204, communications hardware 206, or the like, for receiving a device trust dashboard request. In some embodiments, the communications hardware 206 may receive the device trust dashboard request from user device 106A. A device trust dashboard request may be indicative of a request for user device 106A to access a device trust dashboard for the user. The device trust dashboard request may further include candidate user credentials. In some embodiments, the candidate user credentials may include a user identifier (e.g., a username, email address, and/or the like) and a password (e.g., PIN, biometric data, text password, and/or the like). The candidate user credentials may be used to verify the user, as described in further detail below, which is required prior to providing a device trust dashboard to the requesting user device 106A.

The device trust dashboard request may be received using a hypertext transfer protocol (HTTP) or HTTP secure (HTTPS) protocol. In some embodiments, the device trust dashboard request may include the “GET” HTTP header. In some embodiments, the communications hardware 206 may use various application programming interfaces (APIs), such as WebSocket, or representational state transfer (RESTful) APIs, to communicate with user device 106A.

In some embodiments, the device trust dashboard request may be received from user device 106A using a mobile application, a web application, or the like. The origin of the device trust dashboard request may be determined based on the HTTP header. For example, the HTTP header of the device trust dashboard request may include a ‘user-agent’ header indicative of the type of device and the browser or application used to provide the device trust dashboard request.

As shown by operation 504, the apparatus 200 includes means, such as processor 202, memory 204, verification circuitry 210, or the like, for performing a verification routine for the user based on the candidate user credentials. Once the communications hardware 206 receives the candidate user credentials, the verification circuitry 210 may perform a verification routine for the user based on the candidate user credentials. In particular, the user account associated with the user may be associated user credentials that may be used to authenticate candidate users via user device 106A. In some embodiments, the verification circuitry 210 may use the candidate user identifier of the candidate user credentials to identify the user account to which the candidate user credentials correspond and may then use the candidate password of the candidate user credentials to perform the verification routine. The verification circuitry 210 may access one or more stored passwords associated with the user account using the candidate user identifier and then may compare the stored password against the received candidate password. The verification circuitry 210 may follow a verification routine that includes verification steps to allow for comparison of the stored password and the received candidate password. In an instance in which the verification circuitry 210 determines a match between the stored password and the received candidate password, the user may successfully be verified. Alternatively, in an instance in which the verification circuitry 210 fails to determine a match between the stored password and the received candidate password, the user may fail to be verified.

In some embodiments, the device profile repository 120 may store user accounts and associated user credentials for said user accounts. Alternatively, another storage may be used to store the user accounts and/or associated user credentials. As described above, the candidate user identifier of the received candidate user credentials may be used to identify the corresponding user account. That is, a user account may be associated with a user identifier that uniquely identifies the user account from other user accounts. Thus, the verification circuitry 210 may use the candidate device identifier of the received candidate user credentials to identify a corresponding user profile for a user. The verification circuitry 210 may then perform a verification routine to compare the stored password to the received candidate password.

The password for a user account may be stored in a protected manner. For example, the user credentials may be encrypted using any suitable encryption algorithm and/or may be hashed according to any suitable hash algorithm. Additionally, in some embodiments, a user account may be associated with multiple passwords that correspond to different password types. For example, a user may be associated with passwords corresponding to one or more biometric password types (e.g., retina, fingerprint, facial, voiceprints, and/or the like), a plaintext password type, a PIN password type, and/or the like. Each password type may be characterized by a specific structure such that the password type is identifiable. For example, each password type may have a specific character lengths, character types (e.g., letter characters, numeric characters, alphanumeric characters, special characters, or the like), character formats (e.g., capitalized letters, lowercase letters, or the like), etc. In some embodiments, the verification circuitry 210 may determine the type of candidate password based on the predefined structure of passwords such that the corresponding type of stored password may be used for comparison. In some embodiments, a password type is indicated for the stored passwords of the user account such that the verification circuitry 210 can determine the stored password corresponding to the password type of the received candidate password and may select the appropriate stored password. Additionally, this selective comparison may prevent the verification circuitry 210 from having to compare each stored password to the received candidate password, thereby saving on computational resources and resulting in a more efficient and improved verification routine.

The verification routine may define how to compare the stored user credentials to the received user credentials. The particular operations in the verification routine may define how to decrypt encrypted stored passwords and/or the particular hash algorithm to perform to allow for comparison of a hashed stored password and a received stored password. In particular, the verification routine may provide a method to access or derive a decryption key to decrypt an encrypted stored password. The verification routine may additionally provide the hash algorithm for the verification circuitry 210 to use to transform the received candidate password into a hashed candidate password. In some embodiments, the hash algorithm may require a salt value (e.g. a unique value for each user account) or a pepper value (e.g., a unique value for multiple user accounts). The verification circuitry 210 may be configured to determine the salt value and/or the pepper value associated with the user account and uses these values along with the received candidate password to generate the hashed candidate password.

In some embodiments, in an instance in which the received candidate password is a biometric password type, the verification routine may require the use of a biometric identification model. A biometric identification model may be a machine learning model, such as a CNN or RNN, trained for feature recognition for a particular biometric. For example, one biometric identification model may correspond to a retina password type, another biometric identification model may correspond to a fingerprint password type, another biometric identification model may correspond to a facial password type, and another biometric identification model may correspond to a voiceprint password type. The biometric identification model may be trained to identify features within a corresponding biometric and convert these features into a mathematical representation of the biometric. For example, for a biometric identification model corresponding to a facial password type, the biometric identification model may be trained to analyze distance between a captured user's eyes, the shape of the user's chin, the contours of the user's cheeks and forehead, and/or the like. Thus, the stored password for a biometric password type may be the mathematical representation of the biometric. The verification circuitry 210 may therefore use the biometric identification model corresponding to the biometric associated with the password type of the received candidate password to transform the candidate password (e.g., captured biometric) into a mathematical representation of the biometric. Thus, this may allow the verification circuitry to compare biometrics to determine whether the user can be verified.

Once the verification circuitry 210 has decrypted the encrypted stored password and/or generated the hashed candidate password, the verification circuitry 210 may compare the stored password and the candidate password. In an instance in which a password type of the candidate is not a biometric password type (e.g., the password is a plaintext password type or PIN password type), the verification routine may instruct the verification circuitry 210 to directly compare the stored password to the candidate password. For example, in an instance in which the stored password and the candidate password exactly match, the verification circuitry 210 may successfully verify the user. In an instance in which the stored password and the candidate password do not exactly match, the verification circuitry 210 may fail to verify the user.

In an instance in which the password is a biometric password type, the verification circuitry 210 may again use a biometric comparison model to determine a similarity score between the stored password and the candidate password. The biometric comparison model may be a machine learning model, such as a CNN, configured to determine a degree of similarity between two passwords of a biometric password type, which may be represented as a numerical similarity score. That is, the biometric comparison model may be configured to compare the mathematical representations of two biometrics to determine a degree of similarity between the two biometrics and represent the degree of similarity as a similarity score. In some embodiments, the biometric comparison model is configured to use any suitable technique for the comparison of the stored password and candidate password, such as linear discriminant analysis techniques, local binary pattern histograms, and/or the like. The biometric comparison model may compare a similarity score for two biometrics to a similarity score threshold to determine whether the similarity score satisfies the similarity score threshold. If the similarity score satisfies the similarity score threshold, the biometric comparison model may determine a biometric match. If the similarity score fails to satisfy the similarity score threshold, the biometric comparison model may determine that there is no biometric match. In this way, the biometric comparison model allows for some variability between a stored password and a candidate password due to various perturbations in captured the biometric (e.g., lighting, angles, device resolution, or other variations) but uses the similarity score threshold to maintain an advanced level of integrity for the biometric. In an instance in which the biometric comparison model determines a biometric match, the verification circuitry 210 may successfully verify the user. In an instance in which the biometric comparison model fails to determine a biometric match, the verification circuitry 210 may fail to verify the user.

As shown by operation 506, the apparatus 200 includes means, such as processor 202, memory 204, verification circuitry 210, or the like, for determining whether the user is successfully verified. As described above, the verification circuitry 210 may perform the verification routine to determine whether the user is successfully verified. In particular, in an instance in which the password type is a non-biometric password type and the stored password and the candidate password do not exactly match, the verification circuitry 210 may fail to verify the user. Alternatively, in an instance in which the password type is a non-biometric password type and the stored password and the candidate password exactly match, the verification circuitry 210 may successfully verify the user. In an instance in which the password type is a biometric password type, the verification circuitry 210 may fail to verify the user in an instance in which the biometric comparison model fails to determine a biometric match. Alternatively, in an instance in which the password type is a biometric password type, the verification circuitry 210 may successfully verify the user in an instance in which the biometric comparison model determines a biometric match.

In an instance in which the user fails to be successfully verified, the process proceeds to operation 508. As shown by operation 508, the apparatus 200 includes means, such as processor 202, memory 204, communications hardware 206, verification circuitry 210 or the like, for providing a rejection message. In an instance in which the verification circuitry 210 fails to verify the user, the verification circuitry may generate a rejection message indicative that the provided user credentials could not be verified. The communications hardware 206 may provide the rejection message to user device 106A from which the candidate user credentials were received. Thus, the user may be provided with an indication that the user credentials he/she provided did not match the stored user credentials and may take additional action based on this information, such as providing new candidate user credentials or taking additional actions to recover a user identifier or password for his/her user account.

In an instance in which the user is successfully verified, the process proceeds to operation 510. As shown by operation 510, the apparatus 200 includes means, such as processor 202, memory 204, communications hardware 206, device management circuitry 208, verification circuitry 210, or the like, for providing the device trust dashboard. In an instance in which the verification circuitry 210 successfully verifies the user, the verification circuitry 210 may provide this indication to device management circuitry 208. Device management circuitry 208 may then generate the device trust dashboard for the user, which may be customized with his/her account information and device profile information for the device profiles associated with the user account. The device trust dashboard may therefore include various components representative of a device profile for each device profile associated with the user account. A device profile may include a representation of select device information (e.g., a device name, a device phone number, and/or the like), a device classification, a device trust score, and an authorization rule set.

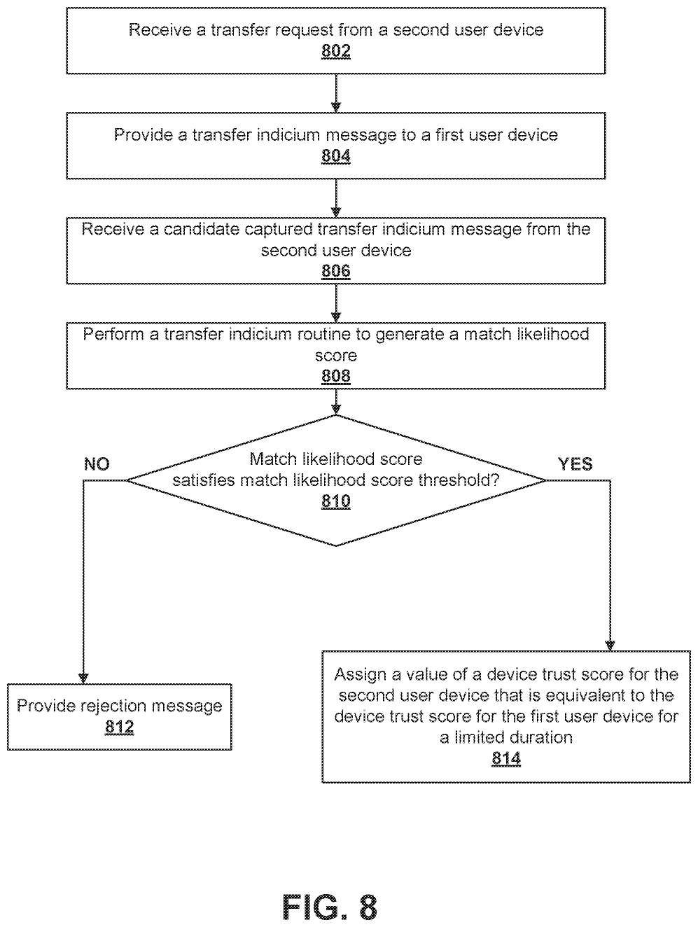

The device trust dashboard may further include one or more interaction elements that allow a user to interact with the device trust dashboard and/or a device profile to view additional information of the device profile for a user device, request a device profile be modified, request a device trust score for a user device be improved, remove a device profile from the device trust dashboard, add a new user device, view a user account access log, temporarily transfer a device trust score (as discussed in greater detail in FIG. 8), and/or the like. These interaction elements may allow a user to interact with them (e.g., touch, select, click, audibly select, and/or the like) to proceed with a corresponding interaction operation.

The device management circuitry 208 may generate the device trust dashboard in a standardized format (e.g., JavaScript Object Notation (JSON), Extensible Markup Language (XML), HTML, an image, and/or the like) and cause the device trust dashboard to be provided to the requesting user device 106A. In particular, the device management circuitry 208 may provide the formatted device trust dashboard to communications hardware 206, and communications hardware 206 may include the device trust dashboard with a device dashboard response to provide the device trust dashboard to the requesting user device 106A.

As described above, the origin of the device trust dashboard request may be determined based on the HTTP header such that the device management circuitry 208 may determine whether the requesting device is using a web application or a mobile application and generate the device trust dashboard based whether a web application or mobile application is being used by the requesting user device 106A. The device management circuitry 208 may be configured to format the device trust dashboard based on whether a mobile application or web application is used. The device management circuitry 208 may determine the amount of content to include in the device trust dashboard, the size of the font and/or interaction elements, and/or other elements of the device trust dashboard based on the type of application used by the requesting user device 106A. For example, the device management circuitry 208 may generate the device trust dashboard for a mobile application with simpler content or less content for a device profile due to the smaller screens as compared to a device trust dashboard for a web application, which may have larger display capabilities. Thus, the device management circuitry 208 may optimize the display of the device trust dashboard for an end user viewing the device trust dashboard on user device 106A.

In some embodiments, the communications hardware 206 may provide the device trust dashboard using HTTP or HTTPS protocols to a mobile application or web application used by the requesting user device 106A. In some embodiments, the communications hardware 206 may use HTTP or HTTPS protocols to provide the device trust dashboard to user device 106A. For example, the communications hardware 206 may provide the device trust dashboard to a mobile application or web application used by user device 106A using an appropriate HTTP response, such as a “POST” method with an appropriate HTTP header. As another example, the communications hardware 206 may use specific APIs, such as RESTful APIs or WebSocket APIs to provide the device trust dashboard to user device 106A. In some embodiments, the communications hardware 206 may use WebSocket APIs to provide the device trust dashboard to user device 106A in real time or near real time without the need for repeated HTTP requests.

As shown by operation 512, the apparatus 200 includes means, such as processor 202, memory 204, communications hardware 206, or the like, for receiving a device modification request. In some embodiments, the communications hardware 206 may receive a device modification request from user device 106A (e.g., user device provided with the device trust dashboard in operation 510) via the device trust dashboard. As described in further detail in FIG. 11, the user device 106A may provide the device modification request in response to user input from the user, such as in response to user interaction with one or more interaction elements of the device trust dashboard. The device modification request pertains to a particular user device, which may be user device 106A or another user device associated with the user account (e.g., any one of user devices 106B-106N). In some embodiments, the device modification request may be indicative of a request to modify a device classification for the user device or modify an authorization rule set for the user device.

In an instance in which the device modification request is indicative of a request to modify a device classification, the device modification request may additionally include an updated value for the device classification for the particular user device. In some embodiments, a device classification is from a predefined list of device classifications. Thus, the updated value for the device classification may be a value from the predefined list of device classifications. For example, the predefined list of device classifications may include a primary user device, a personal user device, a work user device, a shared user device, a limited access device, and/or the like.

In an instance in which the device modification request is indicative of a request to modify an authorization rule set, the device modification request may additionally include an updated value for one or more authorization rules of the authorization rule set, a new authorization rule for the user device, a removal of an authorization rule from the authorization rule set for the user device, a newly added limited user, a removal of a limited user, and/or the like. In some embodiments, an authorization rule may describe a rule and include one or more particular values pertaining to the rule. For example, an authorization rule may be “a maximum transaction limit of $1000”. Here, “$1000” is the value pertaining to the authorization rule. The user may modify a value of the authorization rule while maintaining the authorization rule. Alternatively, the user may wish to delete the authorization rule such that the authorization rule no longer applies to the user device. The user may wish to add a new authorization rule that is currently not included in the authorization rule set. In some embodiments, a new authorization rule may be selected from a predefined list of authorization rules. The predefined list of authorization rules may include one or more default values for the authorization rule, which the user may modify. In some embodiments, the user may additionally add or remove a particular limited user from the device profile. As described above, a limited user may be a user trusted by the user of interest and who is granted with certain limited permissions and/or access to the user account. For example, a limited user may be a spouse, child, parent, sibling, relative, trusted friend, beneficiary, etc. of the user. The user preference set may be indicative of these limited users. In some embodiments, the user may add a new user who is listed as a limited user within the user preference set. This is because the limited user may be required to be associated with his/her own user account and have separate user account credentials. Thus, the user may be required to update a user preference set to reflect a limited user and the limited user may be required to set up his/her own user account prior to the user adding the limited user to the device profile.

Turning now to FIG. 5, as shown by operation 512, the apparatus 200 includes means, such as processor 202, memory 204, communications hardware 206, or the like, for receiving a device modification request. In some embodiments, the communications hardware 206 may receive a device modification request from user device 106A (e.g., user device provided with the device trust dashboard in operation 510). As described in further detail in FIG. 11, the user device 106A may provide the device modification request in response to user input from the user. The device modification request pertains to a particular user device, which may be user device 106A or another user device associated with the user account (e.g., any one of user devices 106B-106N). In some embodiments, the device modification request may be indicative of a request to modify a device classification for the user device or modify an authorization rule set for the user device.

As shown by operation 514, the apparatus 200 includes means, such as processor 202, memory 204, device management circuitry 208, or the like, for updating the device profile corresponding to the user device. Once the communications hardware 206 receives the device modification request, the device management circuitry 208 may process the device modification request to determine the one or more modifications to a device profile requested by the user via the user device. In an instance in which the user device is authorized to make the one or more modifications, the device management circuitry 208 may modify (e.g., update, replace, delete, add, or the like) the requested device profile to reflect the updates provided by the device modification request. In particular, the device management circuitry 208 may access a device profile, which may be stored within the device profile repository 120, and modify the device profile based on the device modification request.

As described above, the device modification request may include an updated value for the device classification for the particular user device. Thus, the device management circuitry 208 may replace the previous value for the device classification with the newly received updated value provided in the device modification request. In an instance in which the device modification request is indicative of a request to modify an authorization rule set, the device modification request may additionally include an updated value for one or more authorization rules of the authorization rule set, a new authorization rule for the user device, a removal of an authorization rule from the authorization rule set for the user device, a newly added limited user, a removal of a limited user, and/or the like. Thus the device management circuitry 208 may replace values of authorization rules with updated values, add a new authorization rule, remove an authorization rule, add a new limited user, or remove a limited user as described by the device modification request.

In some embodiments, prior to modifying the device profile for a user device, the device management circuitry 208 may identify the authorization rule set for the requesting user device 106A to determine whether the particular user device is authorized to request modifications and/or whether modification requirement criteria has been satisfied. The device management circuitry 208 may use the device identifier of the requesting user device 106A, which may be provided by the device trust dashboard request and/or device modification request to identify the corresponding device profile for the user device. The device management circuitry 208 may then determine whether user device 106A is permitted to request modifications and if so, whether modification requirement criteria has been satisfied. For example, an authorization rule may permit the user device user device 106A to modify a device profile in an instance in which a biometric password type was provided (e.g., the modification requirement criteria). Thus, the device management circuitry 208 may determine whether the user credentials received in the device trust dashboard request included a biometric password type and in an instance in which the device trust dashboard request did include a biometric password type, the device management circuitry 208 may determine the modification requirement criteria has been satisfied. Otherwise, the device management circuitry 208 may determine the modification requirement criteria was not satisfied and may not update the device profile. In some embodiments, in an instance in which the user device is permitted to modify a device profile according to modification requirement criteria, the device management circuitry 208 may determine what modification requirement criteria is missing and may provide a request for this modification requirement criteria to the user device using communications hardware 206. In an instance in which the communications hardware 206 receives a response from the user device user device 106A that includes this missing modification requirement criteria, the device management circuitry 208 may update the device profile according to the device modification request.

Once a device profile has been updated, the device management circuitry 208 may provide the user device user device 106A with an updated device trust dashboard. For example, the device management circuitry 208 may generate one or more content updates for a device profile for a device trust dashboard or may generate a new device trust dashboard in a standardized format (e.g., JSON, XML, HTML, an image, and/or the like). The communications hardware 206 may then provide the updated device trust dashboard to the user device using a HTTP or HTTPS protocol, such as by using a “PUT” or “PATCH” HTTP header.

In some embodiments, once a device trust dashboard is provided to a user device as described in operation 510 of FIG. 5, a trust improvement request may additionally or alternatively be received from the user device 106A. In an instance in which, a device improvement request is received, the process may proceed from operation 510 of FIG. 5 to operation 602 of FIG. 6.

Turning to FIG. 6, example operations are shown for providing a trust improvement event. The device trust score may be used for the authorization rule set for the user device such that an improvement in the device trust score may allow the user device to perform more operations. Additionally, the institution associated with the user account may have various device trust score requirements and may further use the device trust score for other various institutional operations, such as providing a user trust score. Thus, it may be desirable for a user to have the capability to improve a device trust score. While a device trust score for a user device may improve on its own through repeated positive patterns of use, it may be desirable for a device trust score to be more quickly improved, such as when a user replaces a previous user device with a new user device. The user may use the device trust dashboard to provide a device trust improvement request pertaining to a user device of interest. A trust improvement event that optimally achieves the desired device trust score may be generated in response to the request.

As shown by operation 602, the apparatus 200 includes means, such as processor 202, memory 204, communications hardware 206, or the like, for receiving a device trust improvement request. In some embodiments, the communications hardware 206 may receive a device trust improvement request from user device 106A (e.g., user device provided with the device trust dashboard in operation 510) via the device trust dashboard. As described in further detail in FIG. 12, the user device 106A may provide the device trust improvement request in response to user input from the user, such as user interaction with one or more interaction elements of the device trust dashboard. The device trust improvement request pertains to a particular user device, which may be user device 106A or another user device associated with the user account (e.g., any one of user devices 106B-106N). For purposes of clarity, the user device to which the device trust improvement request pertains may be referred to as user device 106N. The device trust improvement request may be indicative of a request to improve a device trust score of user device 106N from its current device trust score. Additionally, in some embodiments, the device trust improvement request may further include a target device trust score for the user device 106N.

While the device trust score for a user device may steadily improve in response to repeated successful patterns of positive use, such as successful user account accesses, successful transactions, or the like, the device trust improvement request may provide a mechanism to expedite improvement in the device trust score for user device 106N. This may allow the device trust score to be improved for user device 106N, which may allow user device 106N to perform additional or enhanced operations requiring an improved device trust score. Additionally, the institution associated with the user account may have various device trust score requirements (e.g., device trust score minimums) that are not modifiable by a user. The institution may also use the device trust score for other various institutional operations, such as providing a user trust score. Thus, it may be desirable for a user to have the capability to improve a device trust score.

As shown by operation 604, the apparatus 200 includes means, such as processor 202, memory 204, device management circuitry 208, or the like, for generating a trust improvement event. The device management circuitry 208 may determine a trust improvement event for user device 106N. A trust improvement event may include one or more operations that may be executed or performed by the user device 106N to improve the device trust score for user device 106N. That is, the trust improvement event may include instructions and/or operations for user device 106N to perform. Performance of such instructions and/or operations may be detected by device management circuitry 208 and, in response to detection that the operations of the trust improvement event are performed, may result in the device management circuitry 208 improving the device trust score for the user device 106N. The operations of the trust improvement event may include various operations that can be used to help confirm the user device is associated with the user. By performing the operations of the trust improvement event, the user device 106N may thereby improve its trustworthiness and strengthen its association with the user such that the device management circuitry 208 may improve the associated device trust score for user device 106N.

Additionally, a trust improvement event may be assigned a performance time window that is indicative of an amount of time for which the trust improvement event is valid for. The trust improvement event must be performed within the performance time window to result in an improved device trust score. If a trust improvement event is performed outside the performance time window, the device management circuitry 208 may determine not to improve the associated device trust score. As such, the security of the device profiles and user account may be better maintained.

In some embodiments, the device management circuitry 208 may generate a trust improvement event for user device 106N using a trust improvement event generation model. The trust improvement event generation model may be a machine learning model, such as generative adversarial network (GAN), a transformer model, a large language model, a RNN, and/or the like, that is configured to process a device profile associated with the user device 106N and/or the device trust improvement request to determine a trust improvement event. Alternatively, the trust improvement event generation model may be a rules-based model configured to process the device profile associated with the user device 106N and/or the device trust improvement request and perform logical and/or mathematical operations to determine a trust improvement event.

In some embodiments, trust improvement event generation model may determine a magnitude of change for a device trust score based on the request device trust score and the current device trust score described by the device profile for user device 106N. For example, the requested device trust score may be 7 and the current device trust score described by the device profile may be 5. Thus, the trust improvement event generation model may determine a magnitude of change of 2. In some embodiments, the trust improvement event generation model may be configured with various predefined trust improvement events that are each associated with a device trust improvement score, indicative of the magnitude of improvement that successful completion of the trust improvement event may result in. For example, a trust improvement event may be associated with a device trust improvement score of 0.5, indicative of a 0.5 point device trust score improvement in an instance in which the trust improvement event is completed. Thus, the improvement event generation model may consider the magnitude of change and the trust improvement scores for various trust improvement events when generating a trust improvement event. For example, the trust improvement event generation model may attempt to identify the trust improvement events associated with device trust improvement scores that optimally achieve the required change in magnitude. For example, the trust improvement event generation model may attempt to select a trust improvement event that most closely achieves the requested device trust score. In some embodiments, in an instance in which the magnitude change exceeds all device trust improvement scores of trust improvement events, the trust improvement event generation model may select a trust improvement event closest to the magnitude change. However, in some instances, the required magnitude change is too large such that a single trust improvement event may not achieve the desired change. This may be intentional to limit and/or prevent fraudsters who've gained access to a user account from taking control of a user account. Thus, in some embodiments, in order to maintain security of the user account and/or device profiles, a threshold number of trust improvement events may be provided within a particular time window (e.g., one per day, one per week, one per month, etc.) to prevent any one user device from improving an associated device trust score too quickly.

In some embodiments, the trust improvement event generation model may determine eligible trust improvement events based on a device type of user device 106N described by the device profile. The device type may be indicative of the functionality and/or capabilities of a user device. In some embodiments, the trust improvement event generation model may be configured with a device type list, which may include one or more device types and candidate trust improvement events for each device type. For example, if user device 106N is a smart watch, this device type may not be configured with a camera and thus, the trust improvement events may not include trust improvement events that include operations requiring a camera.

In some embodiments, a trust improvement event may include an instruction to perform an action at one or more candidate automated teller machines (ATMs) using user device 106N. In some embodiments, the trust improvement event generation model may identify one or more candidate ATMs for a user based on an address listed in a user account or based on geographic information provided by user device 106A (e.g., the device accessing the device trust dashboard). The trust improvement event generation model may access a memory and/or database configured with the location of associated and/or operational ATMs and determine candidate ATMs for the user that within a predefined geographic area based on the user's location (e.g., within 20 miles, within a same or neighbouring zip code, within the same town, within the same state, within the same country, and/or the like). The trust improvement event generation model may generate the trust improvement event to describe operations for a user to use user device 106N with one of the candidate ATMs identified for the user. In particular, the trust improvement event may describe that the user is to pre-stage an ATM operation for a candidate ATM using a mobile application on the user device 106N, perform an operation at a candidate ATM using near-field communication (NFC) or Bluetooth with user device 106N, use user device 106N to scan a quick response (QR) code displayed on a candidate ATM, and/or the like.

In some embodiments, a trust improvement event may include an instruction perform a transaction at one or more candidate merchants using user device 106N. In some embodiments, the trust improvement event generation model may identify one or more candidate merchants for a user based on an address listed in a user account or based on geographic information provided by user device 106A (e.g., the device accessing the device trust dashboard). The trust improvement event generation model may access a memory and/or database configured with the location of associated and authenticated merchants and determine candidate merchants for the user that within a predefined geographic area based on the user's location (e.g., within 20 miles, within a same or neighbouring zip code, within the same town, within the same state, within the same country, and/or the like). The trust improvement event generation model may generate the trust improvement event to describe operations for a user to use user device 106N with one of the candidate merchants identified for the user. In particular, the trust improvement event may describe that the user is to perform a transaction at a point-of-sale terminal of a candidate merchant using the user device 106N (e.g., via Bluetooth, NFC) such as by using a mobile wallet and/or the like.

In some embodiments, a trust improvement event may be includes an instruction to perform an authentication routine at one or more candidate institution locations. By way of particular example, a candidate institution location may be a financial institution branch that is staffed with financial institution employees. In some embodiments, the trust improvement event generation model may identify one or more candidate institution locations for a user based on an address listed in a user account or based on geographic information provided by user device 106A (e.g., the device accessing the device trust dashboard). The trust improvement event generation model may access a memory and/or database configured with the location of associated and authenticated candidate institution locations and determine candidate institution locations for the user that within a predefined geographic area based on the user's location (e.g., within 20 miles, within a same or neighbouring zip code, within the same town, within the same state, within the same country, and/or the like). The trust improvement event generation model may generate the trust improvement event to describe operations for a user to perform an authentication routine using the user device 106N at a candidate institution location. In particular, the trust improvement event may describe that the user is to visit a candidate institution location and present a form of identification to an institution employee and additionally provide the institution with device information for user device 106N such that the institution employee may verify the user's identity and the device identity for user device 106N.

In some embodiments, a trust improvement event may be include an instruction to provide a received OTP (e.g., a candidate OTP) in response to receiving an OTP. In some embodiments, the trust improvement event generation model may be configured to generate an OTP that may be provided to the user device 106N. The trust improvement event generation model may generate the OTP using any suitable OTP algorithm, such as a hash-based message authentication code (HMAC) based one-time-password (HOTP) algorithm, a time-based one-time password (TOTP) algorithm, and/or other suitable OTP generation algorithms. The trust improvement event may describe that the user is to provide the received OTP via a mobile application, a web application, and/or the device trust dashboard. In some embodiments, the user need not user the user device 106N to provide the received OTP.

In some embodiments, a trust improvement event may include a selfie request. A selfie request may provide an instruction to provide a captured image of the user's face using the user device 106N. The selfie request may include instructions on how the user should capture the image. For example, the selfie request may provide a reference of the size of the user's face required in the image, request the user is in a well-lit environment, request the user remove extraneous headwear, eyewear, or other facial obstructions, and/or the like.

As shown by operation 606, the apparatus 200 includes means, such as processor 202, memory 204, communications hardware 206, or the like, for providing the trust improvement event. Once the device management circuitry 208 generates the trust improvement event for user device 106N, the communications hardware 206 may provide the trust improvement event to the user. In some embodiments, the communications hardware 206 may provide the trust improvement event to user device 106A (e.g., the user device provided with the device trust dashboard). In some embodiments, the communications hardware 206 may provide the trust improvement event to the user device via the device trust dashboard. For example, the communication hardware may update the device trust dashboard to reflect the trust improvement event and provide the updated device trust dashboard to the user device using a HTTP or HTTPS protocol, such as by using a “PUT” or “PATCH” HTTP header. Additionally or alternatively, the communications hardware may provide the trust improvement event to the user device 106N.

In some embodiments, in an instance in which the trust improvement event may include an instruction to provide a received OTP, the communications hardware 206 may provide the OTP generated by the device management circuitry 208 to the user device 106N.

As shown by operation 608, the apparatus 200 includes means, such as processor 202, memory 204, communications hardware 206, device management circuitry 208, device identification circuitry 212, or the like, for detecting performance of the trust improvement event. In some embodiments, the device management circuitry 208 is configured to monitor for performance of operations described by the trust improvement event during the associated performance time window. The device management circuitry 208 may monitor for performance of the operations based on the type of trust improvement event provided. In some embodiments, the device management circuitry 208 may monitor a user account for access and/or transactions performed by user device 106N. Alternatively, the device management circuitry 208 may monitor for performance of the trust improvement event by determining whether a response has been received from user device 106N and/or another user device associated with the user.

By way of particular example, the device management circuitry 208 may detect performance of a trust improvement event that included instructions to to perform an action at one or more ATMs by monitoring a user account for access by an ATM and access by user device 106N. For example, as described above, device identification circuitry 212 may be configured to monitor for user account access events and generate a user account access log. The device management circuitry 208 may be configured to periodically or semi-periodically analyze the user account access log for a successful user account access by a candidate ATM and/or a successful user account access by user device 106N, where the user account access was used to facilitate an ATM operation. In an instance in which the user device 106N successfully accessed the user account and was used to facilitate an operation with an ATM (e.g., pre-stage an ATM operation, perform an operation at the candidate ATM using NFC or Bluetooth, scan a QR code displayed on the candidate ATM), the device management circuitry 208 may conclude performance of the trust improvement event.

As another example, the device management circuitry 208 may detect performance of a trust improvement event that included instructions to perform a transaction at one or more candidate merchants by monitoring a user account for transaction within the user account associated with a candidate merchant that involved the user device 106N. For example, as described above, device identification circuitry 212 may be configured to monitor for user account access events that may also include user account transactions. A user account transaction may be indicative of the parties of the transaction, which may include an origin device (e.g., user device 106N) and a point-of-sale terminal. The device management circuitry 208 may be configured to periodically or semi-periodically analyze the user account access log and/or a user account transaction log to identify a transaction that occurred at a candidate merchant and involved the user device 106N. In an instance in which the user device 106N successfully performed a transaction with the candidate merchant, the device management circuitry 208 may conclude performance of the trust improvement event.

As another example, the device management circuitry 208 may detect performance of a trust improvement event that included instructions to visit a candidate institution location and perform an authentication routine using user device 106N. In some embodiments, an institution employee may provide an indication confirming the user performed an authentication routine at the candidate institution location. For example, the user may have provided a form of identification (e.g., driver's license, passport, birth certificate, national identification card, social security card, or the like) to the institution employee and additionally provided the institution employee with device information for user device 106N such that the institution employee may verify the user's identity and the device identity for user device 106N. The institution employee may use a computing device to log into a secure employee network using his/her institutional employee credentials. The institution employee may then access the user account for the user and provide an indication that the user completed an authentication routine using user device 106N. For example, the indication may include device information, such as a user identifier for the user device 106N such that the device management circuitry 208 may determine that it was user device 106N that was used for the authentication routine. The device management circuitry 208 may then receive a notification from communications hardware 206 indicative that the user completed the authentication routine. In an instance in which the user device 106N successfully completed the authentication routine using user device 106N, the device management circuitry 208 may conclude performance of the trust improvement event.

As another example, the device management circuitry 208 may detect performance of a trust improvement event that included instructions to provide an OTP that was provided to user device 106N. In some embodiments, the communications hardware 206 may receive a candidate OTP from a user device associated with the user. The user device providing the candidate OTP may be user device 106N or may be another user device associated with the user. In some embodiments, the communications hardware 206 may receive the candidate OTP from the user device via a web application or mobile application. The device management circuitry 208 may then perform an authentication routine to attempt to authenticate the candidate OTP received from the user device. In particular, the device management circuitry 208 may compare the received candidate OTP to the OTP provided to the user device 106N using any suitable OTP method and determine whether there is a match. In an instance in which the received candidate OTP matches the OTP provided to the user device 106N, the device management circuitry 208 may successfully authenticate the candidate OTP. In an instance in which the received candidate OTP does not match the OTP provided to the user device 106N, the device management circuitry 208 may fail to authenticate the candidate OTP. In an instance in which the received candidate OTP is authenticated, the device management circuitry 208 may conclude performance of the trust improvement event.

As another example, the device management circuitry 208 may detect performance of a trust improvement event that includes a selfie request that was provided to user device 106N. In some embodiments, the communications hardware 206 may receive a selfie response from user device 106N. The selfie response may include a candidate captured image. The device management circuitry 208 may identify one or more stored authenticated user images associated with the user account. In some embodiments, the one or more stored authenticated user images may be a driver's license photo, an image of the user captured by a financial institution device, or an image of the user uploaded by the user in the user account. In some embodiments, the device management circuitry 208 may use the biometric comparison model described above in operation 504 of FIG. 5, to generate a similarity score between the received candidate captured image and the one or more authenticated user images associated with the user account. The biometric comparison model may compare a similarity score between the candidate captured image and an authenticated user image to a similarity score threshold to determine whether the similarity score satisfies the similarity score threshold. In an instance in which the similarity score satisfies the similarity score threshold, the biometric comparison model may determine a biometric match for the user. In an instance in which the similarity score fails to satisfy the similarity score threshold, the biometric comparison model may determine that there is no biometric match. In an instance in which a biometric match is determined, the device management circuitry 208 may conclude performance of the trust improvement event.

As shown by operation 610, the apparatus 200 includes means, such as processor 202, memory 204, device management circuitry 208, or the like, for updating the device trust score in the device profile in an instance in which the trust improvement event is successfully performed. As described above, a trust improvement event may be associated with a device trust improvement score, indicative of the magnitude of improvement that successful completion of the trust improvement event may result in. Thus, in an instance in which the device management circuitry 208 detects performance of the trust improvement event, the device trust score may be improved by the device trust improvement score and the device trust score for the user device may be updated to reflect the improved device trust score value. In an instance in which the device profile is stored within the device profile repository 120, the device management circuitry 208 may access the stored device profile to modify the device trust score of the device profile corresponding to user device 106N.

### Device Profile Utilization

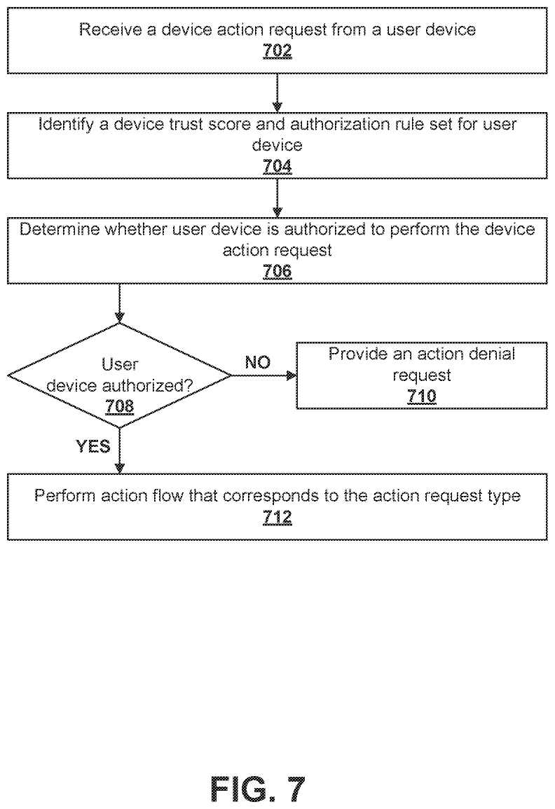

Turning first to FIG. 7, example operations are shown for determining a response to a device action request. The device profile that may be managed by the user via the device trust dashboard may be used when determining whether a user device is authorized to perform a particular device action indicated in a device action request. For example, a device action request may correspond to a transaction request for a particular transaction amount to be performed by a particular user device. The device trust score and authorization rule set for the device profile of the user device may be accessed and used to determine whether the user device is authorized to perform such an action. Additionally, in some embodiments, the user account access log in the device profile may establish a pattern for the user device that may be used to determine whether additional authentication operations are required prior to proceeding with an action flow, even in an instance in which the user device is otherwise authorized to perform the device action.

As shown by operation 702, the apparatus 200 includes means, such as processor 202, memory 204, communications hardware 206, operations circuitry 214, or the like, for receiving a device action request from a user device. The device action request may be received by communication hardware 206 from user device 106A. User device 106A need not be accessing a user account or device trust dashboard to provide the device action request, but in some embodiments, may currently be accessing the user account or device trust dashboard.

The device action request may include an action request type and request information. An action request type may be indicative of a type of action requested to be performed by user device 106A. The action request type may correspond to a candidate device action types, which may be predefined and stored in an associated memory, such as memory 204. Candidate device action types may include a request to access a user account, facilitate a transaction, transfer funds from a user account, deposit a digital check, checking user account balances, view user account information (e.g., name, address, phone number, email, and/or the like), modify user account, change user account credentials (e.g., a password), download user account documents, set up recurring payments, apply for various products or services, request user account cards (e.g., credit cards, debit cards, or other cards associated with the user account), lock or unlock user account cards, request replacement user account cards, manage user account alerts, and/or the like.

In some embodiments, operations circuitry 214 may be configured to identify the action request type of the device action request based on a structure or format of the device action request. For example, in some embodiments, the device action request may include a header indicative of the type of action request type such that the operations circuitry 214 may automatically determine the action request type based on the header. Alternatively, in some embodiments, the operations circuitry 214 may be configured to use natural language processing techniques and/or machine learning models to identify key words, phrases, or patterns within the device action request and determine the action request type based on this identification.

The device action request may additionally include request information. The request information may be indicative of the user device associated with the device action request. For example, the device action request may be indicative of a device identifier that may be used to identify user device 106A. The request information may further be indicative of details needed to complete an action flow for the specific action request type. For example, a facilitation of a transaction request type may require an indication of a recipient user device, an associated recipient user, a transaction amount, and/or the like. As another example, a change user account credentials request type may require a previous user account credential and a new requested user account credential. In some embodiments, the request information may additionally include user credentials.

As shown by operation 704, the apparatus 200 includes means, such as processor 202, memory 204, communications hardware 206, operations circuitry 214, or the like, for identifying a device trust score and authorization rule set for the user device. The operations circuitry 214 may use the device identifier provided in the device action request to identify a device profile for user device 106A. The operations circuitry 214 may then analyze the device profile for user device 106A to determine the device trust score and authorization rule set for user device 106A. In some embodiments, in an instance in which device profiles are stored in the device profile repository, the operations circuitry 214 may access the device profile repository 120 to identify the device profile for user device 106A.

In some embodiments, the operations circuitry 214 may determine the device trust score for the user device 106A based on the authorization rule set. For example, an authorization rule set may include an authorization rule requiring that a biometric credential is required in order to attain the current device trust score. Otherwise, the device trust score may be capped at a particular value (e.g., 7). Thus, the operations circuitry 214 may determine whether the request information of the device action request includes user credentials and if so, whether a biometric user credential is included. Additionally, the operations circuitry 214 may perform a verification routine for the user based on the provided user credentials in a substantially similar manner as described in operation 504 of FIG. 5. By way of continuing example, in an instance in which a biometric user credential is provided in the request information of the device action request and the user is successfully verified, the operations circuitry 214 may determine the device trust score to be the value described by the device profile (e.g., 10). In an instance in which a biometric user credential is not provided in the request information of the device action request (e.g., no user credentials are provided or a non-biometric user credential is provided), the operations circuitry 214 may determine the device trust score to be the capped value (e.g., 7) described by the authorization rule set.

As shown by operation 706, the apparatus 200 includes means, such as processor 202, memory 204, communications hardware 206, operations circuitry 214, or the like, for determining whether the user device is authorized to perform the device action request. In particular, the operations circuitry 214 may then determine whether the authorization rule set for user device 106A is indicative that the user device is authorized to perform the action request type of the device action request.

Additionally, the operations circuitry 214 may determine whether the device action request and/or user device 106A satisfy one or more institution requirements. The one or more institution requirements may be maintained and managed by an institution associated apparatus 200. Institution requirements may include institution device trust score thresholds, authentication requirements (e.g., whether user credentials are needed), whether additional analysis procedures are required, and/or the like. The institution requirements may be stored in a memory, such as memory 204, or another memory location accessible to operations circuitry 214. Additionally, the institution requirements may be associated with a particular action request type such that different action request types may have different institution requirements.

The institution requirements may define one or more institution device trust score thresholds for an action request type. The one or more institution device trust score thresholds may diverge from the authorization rules included in the authorization rule set as configured by the user. However, to ensure compliance with various institutional security protocols and safeguards, the operations circuitry 214 may be required to ensure that the device trust score for user device 106A satisfies the one or more institution device trust score thresholds.

Additionally, the institution requirements may define authentication requirements required for the action request type. For example, the authentication requirement may define that the request information of the device action includes user credentials and may further define a particular type of user credential required. An authentication requirement may further define that the user must be successfully verified using a verification routine. The operations circuitry 214 may thus determine whether the action request type is associated with authentication requirements and if so, may identify whether the request information of the device action request includes user credentials. If so, the operations circuitry 214 may perform the verification routine for the user using the user credentials in a substantially similar manner as operation 504 of FIG. 5. If the request information does not include user credentials or in an instance in which the user fails to be verified using the verification routine, the operations circuitry 214 may determine the device action request fails to satisfy the authentication requirements. In an instance in which the user is successfully verified using the verification routine, the operations circuitry 214 may determine the device action request satisfies the authentication requirements.

In some embodiments, the institution requirements define additional analysis procedures that are required for the action request type. The additional analysis procedures may be reserved for action request types that are considered high security risk actions or may significantly impact a user account, such as high-value transaction, user credential changes, modifying user account information, and/or the like. In some embodiments, the additional analysis procedure may require an analysis of the device action request as compared to historical user device patterns. To facilitate this, the operations circuitry 214 may use a pattern recognition model to identify historical pattern for the user device to determine an anomaly score for the device action request. The additional analysis procedures may define additional operations based on the anomaly score. For example, in an instance in which the anomaly score satisfies one or more anomaly score thresholds, the device action request may be determined to satisfy the additional analysis procedure. In an instance in which the anomaly score fails to satisfy the one or more anomaly score thresholds, the device action request may be determined to fail to satisfy the additional analysis procedure. In an instance in which the device action request is determined to fail to satisfy the additional analysis procedure, the additional analysis procedure may require that an additional authentication metric be provided by user device 106A. For example, the additional analysis procedure may require an OTP is provided to the user device 106A or another user device associated with the user account using communications hardware 206 and the recipient user device provides the OTP back to communications hardware 206. The additional analysis procedure may be satisfied in an instance in which the user device provides back the OTP and the OTP is successfully verified.

The pattern recognition model may be a machine learning model, such as a CNN or RNN, configured to process an account access log associated with the user device to identify access and/or user device use patterns for the user device and additionally process the device action request to determine an anomaly score for the user device. An anomaly score may indicative of how closely the user device associated with the device action request is following historical patterns. As described above, the user account access log of a particular device profile may provide a user device pattern that may be used to help authenticate the user device. The user account access log may provide insights into geographical, temporal, or digital signal patterns that may be used to help authenticate a particular user device. The pattern recognition model may compare various features from the historical patterns of various user account events associated with the user device to features included in the device action request to determine the anomaly score. The pattern recognition model may use any suitable techniques for this comparison, such as clustering techniques (e.g., K-nearest neighbors, density-based spatial clustering of applications (DBSCAN), affinity propagation, and/or the like), support vector machines (SVMs), etc. In some embodiments, the pattern recognition model may determine the anomaly score based on one or more Euclidean distance metrics between a point corresponding to the device action request and one or more historical user device access events.

As shown by operation 708, the apparatus 200 includes means, such as processor 202, memory 204, operations circuitry 214, or the like, for determining whether the user device is determined to be authorized to perform the device action request. In an instance in which the authorization rule set is indicative that the user device is authorized to perform the action request type of the device action request and the user/user device satisfies the institution requirements (e.g., the device trust satisfies the one or more institution device trust scores, the device action request/user satisfy the authentication requirements, and/or the device action request/user satisfy the additional analysis procedures), the user device 106A may be determined to be authorized to perform the device action request. Otherwise, the user device 106A may fail to be authorized to perform the device action request.

In an instance in which user device is determined to fail authorization to perform the device action request, the process proceeds to operation 710. As shown by operation 710, the apparatus 200 includes means, such as processor 202, memory 204, communications hardware 206, or the like, for providing an action denial request. In an instance in which the user device 106A is not authorized to perform the device action request, the communications hardware 206 may provide an action denial request indicative that the user device 106A is not authorized to perform the device action request. In some embodiments, the action denial request may additionally provide the reason for the authorization failure.

In an instance in which user device is authorized to perform the device action request, the process proceeds to operation 712. As shown by operation 712, the apparatus 200 includes means, such as processor 202, memory 204, communications hardware 206, operations circuitry 214, or the like, for performing an action flow that corresponds to the action request type. In an instance in which the user device is authorized to perform the device action request, the operations circuitry 214 may perform the action flow associated with the action request type. In some embodiments, each candidate action request type may be associated with a defined action flow that describes a series of actions that are required to be performed to complete the action request type.

The operations circuitry 214 may identify the action flow corresponding to the action request type and may perform the operations defined by the action flow. In some embodiments, an operation of the action flow may require a particular value to be input in order for the operation to be performed. Operations circuitry 214 may input the required values for the order based on the request information of the device action request. For example, an operation of an action flow corresponding to a change user account credentials request type may include verifying a previous user account credential and updating the user account credential to reflect a new user account credential. The request information of the device action request may provide the values of the previous user account credential and the new user account credential such that the operations circuitry 214 may perform these operations.

Turning first to FIG. 8, example operations are shown for performing a transfer indicium routine. The device trust dashboard may also provide the user with the ability to perform unique operations to facilitate operations on a user device that the user device may normally not be able to perform. In particular, the user may request a transfer request from a second user device, which may be indicative of a request to temporarily transfer a device trust score of a first user device to the second user device. To facilitate the transfer request, a transfer indicium message may be provided to the first user device, which may display the transfer indicium. The second user device may be required to capture and provide the captured transfer indicium, which may then be verified to ensure it matches the provided transfer indicium. If a match is determined, the value of the device trust score for the second user device may be made equivalent to the value of the device trust score for the first user device for a limited duration. This series of operations is enabled by the device trust dashboard and would ordinarily not be possible. Thus, the device trust dashboard allows for conventionally unavailable interaction between user devices for the benefit of the user.

As shown by operation 802, the apparatus 200 includes means, such as processor 202, memory 204, communications hardware 206, or the like, for receiving a transfer request from a second user device. In some embodiments, the communications hardware 206 may receive a transfer request from a second user device, such as user device 106B via the device trust dashboard. The transfer request may be indicative of a request to transfer a device trust score from a first user device, such as user device 106A, to user device 106B. The transfer request may be indicative of a device identifier for the first user device 106A and device identifier for the second user device 106B. Thus, the device profiles of the user devices may be identified and used to facilitate the transfer request.

The transfer request may allow the value of the device trust score for user device 106A to temporarily be assigned as the device trust score for user device 106B. In particular, the user device 106B may be assigned a value equivalent to the value of the device trust score for user device 106A for a limited duration (e.g., 1 minute, 1 hour, 1 day, or the like). This may allow a user to perform operations using user device 106B that user device 106B would ordinarily not be able to perform. However, by enabling interaction between two user devices associated with the user account, this close spatial proximity requirement of the two user devices may be sufficient as evidence that the second user device 106B is also associated with the user and therefore, is similarly trustworthy.

As shown by operation 804, the apparatus 200 includes means, such as processor 202, memory 204, communications hardware 206, device management circuitry 208, or the like, for providing a transfer indicium message to a first user device. In response to receipt of the transfer request, the device management circuitry 208 may be configured to generate a transfer indicium message to the first user device 106A. The transfer indicium message may include instructions for rendering a transfer indicium on the first user device 106A. In some embodiments, the transfer indicium is a unique pattern representative of encoded information. The transfer indicium may be capable of being scanned or captured by a camera such that the second user device 106B may capture an image of the transfer indicium displayed on a first user device 106A. In some embodiments, the transfer indicium may be a QR code, a barcode, a uniquely generated picture, a tag, or other image that may visually represent encoded information.

In some embodiments, the information encoded within the transfer indicium may be a particular URL that may correspond to an authentication endpoint. In some embodiments, the information may be a random number generated by the device management circuitry 208. In some embodiments, the information may be an OTP generated by the device management circuitry 208 for the first user device 106A. That is, the device management circuitry 208 may use a system key associated with the first user device 106A to generate the OTP for the transfer indicium. In some embodiments, the device management circuitry 208 may follow a transfer indicium protocol to determine the particular information to be encoded. The transfer indicium protocol may define the particular information to be used (e.g., a URL, random number, OTP, or the like) as well as one or more algorithms or generation models that may be used to generate the information.

In some embodiments, the device management circuitry 208 may use an indicium generation model to transform the information into the transfer indicium. The indicium generation model may be a machine learning model, such as a GAN, variational autoencoder (VAE), a CNN, a transformer model, latent diffusion model, or the like, that is trained to generate transfer indicium that includes encoded information (e.g., a URL, random number, OTP, or the like). For example, the indicium generation model may be configured to encode the generated information into a particular format representative of the information. The dimensions of the transfer indicium may depend on the size of the information to be encoded and a level of error correction to be added into the transfer indicium. Error correction may improve the transfer indicium's resilience to damage of distortion. Error correction may involve encoding a particular amount of redundant information within the transfer indicium. The indicium generation model may output the transfer indicium that contains the encoded information to the device management circuitry 208.

The device management circuitry 208 may then generate the transfer indicium message, which includes the transfer indicium and instructions for rendering the transfer indicium on the first user device 106A. The communications hardware 206 may then provide the transfer indicium message to the first user device 106. The transfer indicium message may thus provide the first user device 106A with the transfer indicium that it can display such that the second user device 106B may capture the displayed transfer indicium if it is within sufficient proximity of the first user device. In some embodiments, the transfer indicium message may be provided to the first user device as a push notification such that it may prompt a user to interact with the transfer indicium message on the first user device 106, such as to authorize the first user device 106A to display the transfer indicium.

As shown by operation 806, the apparatus 200 includes means, such as processor 202, memory 204, communications hardware 206, or the like, for receiving a candidate captured transfer indicium message from the second user device. The communications hardware 206 may receive a candidate captured transfer indicium message from second user device 106B via the device trust dashboard. The candidate captured transfer indicium message may include a captured image depicting candidate transfer indicium. For example, the second user device 106B may use an associated camera to capture an image of the transfer indicium displayed by the first user device and may provide this captured image depicting the candidate transfer indicium (e.g., transfer indicium to be compared to the transfer indicium provided to the first user device 106A).

As shown by operation 808, the apparatus 200 includes means, such as processor 202, memory 204, verification circuitry 210, or the like, for performing a transfer indicium routine to generate a match likelihood score. Once the communications hardware 206 receives the candidate captured transfer indicium message from the second user device 106B, verification circuitry 210 may be used to perform a transfer indicium routine to generate a match likelihood score based on a comparison of the received candidate captured transfer indicium to the original transfer indicium (e.g., provided to the first user device). In some embodiments, the verification circuitry 210 may use an indicia comparison model to perform the comparison of the candidate captured transfer indicium to the original transfer indicium to generate the match likelihood score. The indicia comparison model may be a machine learning model, such as a GAN, VAE, a CNN, a transformer model, latent diffusion model, or the like or a rules-based model that is trained to decode the encoded information in the candidate capture transfer indicium to generate decoded candidate information. This decoded candidate information may be compared to the original information that was encoded into the original transfer indicium to generate the match likelihood score. In some embodiments, the match likelihood score may be determined based on a number of characters corresponding to a particular character position determined to match between the original information and the decoded candidate information. In some embodiments, the original information and decoded candidate information may contain the same number of characters and each character may correspond to a character position indicative of the particular position of the character with reference to the other characters. For example, information that describes “example” may have 7 characters and the “x” character may correspond to the second character position. Thus, the indicia comparison model may determine the match likelihood score based on a comparison of the number of characters at particular character position that are determined to match between the decoded candidate information and the original information.

As shown by operation 810, the apparatus 200 includes means, such as processor 202, memory 204, verification circuitry 210, or the like, for determining whether the match likelihood score satisfies a match likelihood score threshold. Once the verification circuitry 210 determines the match likelihood score for the candidate decoded information of the candidate transfer indicium, the verification circuitry 210 may determine whether the match likelihood score satisfies a match likelihood score threshold. The match likelihood score threshold may be a value defined by one or more authorized users (e.g., administrators associated with apparatus 200) that control the accuracy and/or selectivity required of the match likelihood score. The match likelihood score threshold may define a value that requires a high accuracy while still allowing for the occurrence of various perturbations or distortions that may occur when the second user device 106B captures an image of the transfer indicia displayed on the first user device 106A, thereby allowing for some flexibility.

In an instance in which the match likelihood score fails to satisfy the match likelihood score threshold, the process proceeds to operation 812. As shown by operation 812, the apparatus 200 includes means, such as processor 202, memory 204, communications hardware 206, device management circuitry 208, verification circuitry 210, or the like, for providing a rejection message. In an instance in which the match likelihood score fails to satisfy the match likelihood score threshold, this may be indicative that the candidate information of the candidate transfer indicium could not be verified and thus, it cannot be confirmed that the candidate transfer indicium provided by the second user device 106B is corresponds to the original transfer indicium. As such, the verification circuitry 210 may generate a rejection message indicative that the provided candidate transfer indicium could not be verified. In some embodiments, the second user device 106B may provide a limited number of additional candidate captured transfer indicium message attempts such operations 806-810 may be repeated a limited number of attempts. If the resulting match likelihood score fails to satisfy the match likelihood score threshold for each of the limited number of attempts, the second user device 106B may be flagged and/or a device classification for the second user device 106B may be updated to reflect a fraudulent user device. The device management circuitry 208 may also update the device trust score for the second user device 106B based on the updated device classification or flag. In some embodiments, the device management circuitry 208 may additionally ignore additional transfer request received from the second user device 106B for a particular time frame. This may allow a user time to access his/her device trust dashboard using another user device 106A and modify the device profile for the second user device 106B or remove the second user device 106B in an instance in which this user device has been compromised or stolen.

In an instance in which the match likelihood score satisfies the match likelihood score threshold, the process proceeds to operation 814. As shown by operation 814, the apparatus 200 includes means, such as processor 202, memory 204, communications hardware 206, device management circuitry 208, or the like, for assigning a value of a device trust score for the second user device that is equivalent to the device trust score for the first user device for a limited duration. In an instance in which the match likelihood score satisfies the match likelihood score threshold, the device management circuitry 208 may assign a value of the device trust score for the second user device 106B to a value that is equivalent to the device trust score for the first user device 106A for a limited duration. In an instance in which the device profile is stored in the device profile repository 120, the device management circuitry 208 may access the device profile repository 120 to update the corresponding device profile for the second user device 106B.

Once the limited duration time period has elapsed, the device trust score may automatically revert to the original device trust score associated with user device 106B. However, during the limited duration time period, the user device 106B may be associated with the device trust score value equivalent to the device trust score of user device 106A, such that the second user device 106B may be authorized to perform various operations or actions it would ordinarily not be able to perform. In some embodiments, the device management circuitry 208 may additionally generate an indication that the transfer indicium routine was successfully performed for the second user device 106B and use communications hardware 206 to provide this indication to the second user device 106B and/or first user device 106A. Thus, the user may be made aware of that the transfer indicium is successful and may proceed to use the second user device 106B with the temporarily updated device trust score.

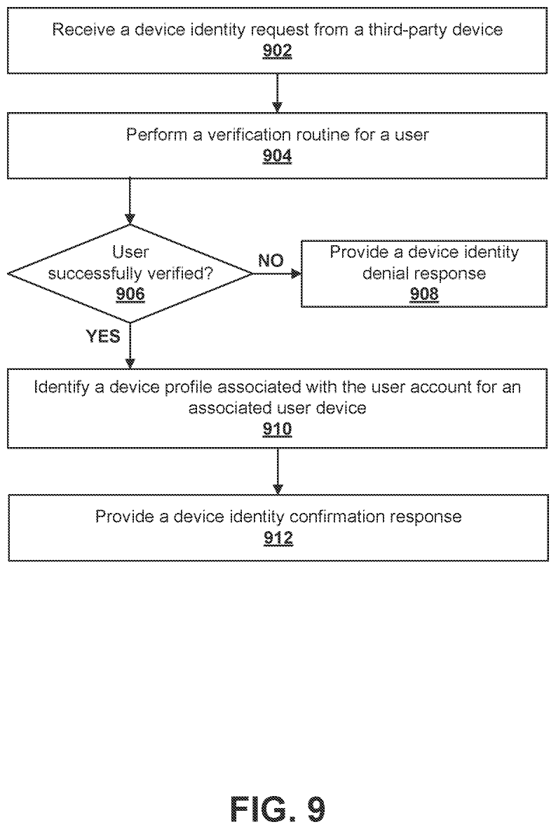

Turning first to FIG. 9, example operations are shown for determining a response to a login request received from a third-party device. In some embodiments, users may wish to leverage the device profiles managed by apparatus 200 for use with institutions other than the institution associated with the user account (e.g., third-party institutions). Thus, users may use their institution user credentials (e.g., user credentials associated with apparatus 200) to log into a third-party user account, which may cause the third-party institution with a device identity request. The apparatus 200 may verify the institution user credentials and in an instance in which the user is successfully verified, the third-party institution may be provided with at least a portion of the device profile information of the user device used to perform the log in operation, such as the device trust score associated with this user device. This may additionally aid third-party institutions that lack the capabilities or technology to determine a device trust score by simply providing the device trust score to said third-party institutions that would ordinarily not be available to them. The particular device profile information provided to the third-party institution may be managed within the authentication rule set such that the user may control the particular information provided.

As shown by operation 902, the apparatus 200 includes means, such as processor 202, memory 204, communications hardware 206, or the like, for receiving a device identity request from a third-party device. In some embodiments, the communications hardware 206 may receive the device identity request from a third-party device, such as any one of third-party devices 108A-108N. A device identity request may be indicative of a request from a third-party institution for apparatus 200 to provide information regarding one or more user devices associated with the user. The device identity request may include candidate user credentials. In some embodiments, the candidate user credentials may include a user identifier (e.g., a username, email address, and/or the like) and a password (e.g., PIN, biometric data, text password, and/or the like). The candidate user credentials may be used to verify the user, as described in further detail below, which is required prior to providing a device identity confirmation response to the requesting third-party device. In some embodiments, the device identity request may be received from the third-party device in an instance in which a user attempts to log into a third-party user account associated with the third-party institution using the user credentials associated with the user account managed by the institution associated with apparatus 200. The user may also attempt to log into a third-party user account using a user device, such as user device 106A. In some embodiments, the device identity request may further describe a device identifier for user device 106a.

As shown by operation 904, the apparatus 200 includes means, such as processor 202, memory 204, verification circuitry 210, or the like, for performing a verification routine for the user. In some embodiments, the verification circuitry 210 may perform the verification routine for the user based on the user credentials provided in the device identity request. The verification circuitry 210 may perform the verification routine in a substantially similar manner as described in operation 504 of FIG. 5.

As shown by operation 906, the apparatus 200 includes means, such as processor 202, memory 204, verification circuitry 210, or the like, for determining whether the user was successfully verified. The verification circuitry 210 may determine whether the user was verified based on the outcome of the verification routine performed in operation 904. The verification circuitry 210 may determine whether the user was verified in a substantially similar manner as described in operation 506 of FIG. 5.

In an instance in which the user fails to be successfully verified, the process proceeds to operation 908. As shown by operation 908, the apparatus 200 includes means, such as processor 202, memory 204, communications hardware 206, verification circuitry 210, or the like, for providing a device identity denial response. In an instance in which the verification circuitry 210 fails to verify the user, the verification circuitry 210 may generate a device identity denial response indicative that the provided user credentials could not be verified. The communications hardware 206 may provide the device identity denial response to the requesting third-party device from which the device identity request was received. Thus, the third-party institution may be provided with an indication that the user credentials provided by the user did not match the stored user credentials and thus, additional information for the device profile associated with the user cannot be provided.

In an instance in which the user is successfully verified, the process proceeds to operation 910. As shown by operation 910, the apparatus 200 includes means, such as processor 202, memory 204, device management circuitry 208, or the like, for identifying a device profile associated with the user account for an associated user device. The device management circuitry 208 may identify a device profiles associated with a user account of the user based on the user credentials (e.g., a user identifier) provided in the device identity request. The device management circuitry 208 may determine device profiles associated with the user account and may further identify the particular device profile for the user device described by the device identifier in the device identity request. In some embodiments, the device management circuitry 208 may access a device profile repository 120 to identify the device profile.

In some embodiments, the device management circuitry 208 may further identify one or more additional device profiles of interest. In particular, the user preference set may describe user preferences for providing device profile information to one or more third-party institutions. For example, the user preference set may describe user preferences indicative that any device profile that is associated with a cell phone device type or tablet device type may be provided to a third-party institution. The device management circuitry 208 may use the user preference set to identify one or more additional device profiles that the user has authorized to be provided to the third-party institution. In this way, this may allow the user to proactively provide his/her user device information for relevant user devices to a third-party entity without individually logging into the third-party institution with each user device. Thus, the device management circuitry 208 may proactively provide relevant user device information to the third-party entity and may thus conserve network bandwidth.

As shown by operation 912, the apparatus 200 includes means, such as processor 202, memory 204, communications hardware 206, device management circuitry 208, or the like, for providing a device identity confirmation response. Once the device management circuitry 208 identifies relevant device profiles for the device identity request, the device management circuitry 208 may generate a device identity confirmation response. In some embodiments, the device identity confirmation response may include the device trust score associated with the device profile for each identified user device of interest, including the device trust score associated with user device 106A. The communications hardware 206 may provide the device identity confirmation response to the requesting third-party device. Thus, the third-party institution may be provided with accurate device trust scores for relevant user devices associated with the user such that the third-party entity need not calculate the device trust scores themselves. This may be particularly beneficial for smaller third-party institutions that lack the resources or technological capabilities to generate device trust scores.

Additionally, in some embodiments, the device identity confirmation response may further include other device information from the device profile, such as a device classification, one or more authorization rules of the authorization rule set, and/or the like. The device management circuitry 208 may determine the particular device information to include in the device identity confirmation based on the user preference set and/or institutional standards. Institutional standards may provide one or more rules that define what internal information (e.g., device information, user information, etc.) can be provided to a third-party institution. The institutional standards may be set by an authorized user (e.g., an administrator associated with the institution that operates apparatus 200) and may safeguard providing personal identifiable information or other sensitive data pertaining to the user or an associated user device to external institutions.

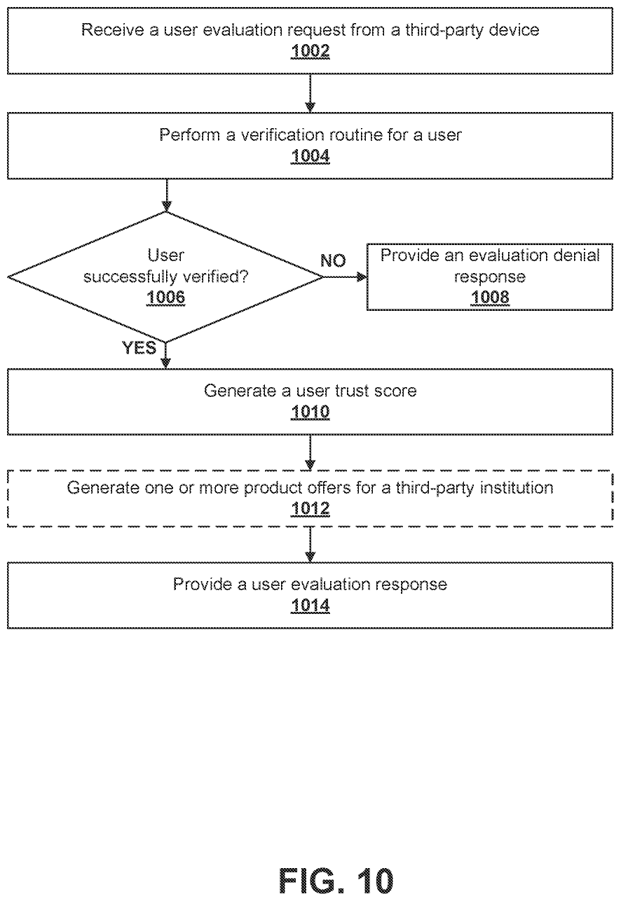

Turning first to FIG. 10, example operations are shown for determining a response to a user evaluation request received from a third-party device. The device profiles associated with the user account of the user may be considered an extension of the user's identity. In some embodiments, the device profiles of user devices associated with the user account may be analyzed and used to generate a user trust score for the user. The user trust score may be indicative of the trustworthiness of the user based on the user's behavior with his/her associated user devices. In some embodiments, third-party entities may be interested in a user trust score in addition to or in lieu of the user device information. For example, a third-party institution that offers services and/or products designed for in person use (e.g., resorts, hotels, car rentals, and/or the like) may wish to have an indication of the trustworthiness of the user and may reward users with high trustworthiness. Thus, users may use their institution user credentials to log into a third-party user account and in an instance in which the user is successfully verified, the user trust score may be provided to the third-party institution. In some embodiments, one or more product offers may additionally be generated for the third-party institution based on the user trust score.

As shown by operation 1002, the apparatus 200 includes means, such as processor 202, memory 204, communications hardware 206, or the like, for receiving a user evaluation request from a third-party device. In some embodiments, the communications hardware 206 may receive the user evaluation request from a third-party device, such as any one of third-party devices 108A-108N. A user evaluation request may be indicative of a request from a third-party institution for apparatus 200 to a user trust score indicative of an inferred trustworthiness of user associated with the user account. A user trust score may be determined based on the device profiles associated with the user account and the behavior of associated user devices. The user evaluation request may include candidate user credentials. In some embodiments, the candidate user credentials may include a user identifier (e.g., a username, email address, and/or the like) and a password (e.g., PIN, biometric data, text password, and/or the like). The candidate user credentials may be used to verify the user, as described in further detail below, which is required prior to providing a user evaluation response to the requesting third-party device. In some embodiments, the user evaluation request may be received from the third-party device in an instance in which a user attempts to log into a third-party user account associated with the third-party institution using the user credentials associated with the user account managed by the institution associated with apparatus 200. The user may also attempt to log into a third-party user account using a user device, such as user device 106A. In some embodiments, the user evaluation request may further describe a device identifier for user device 106a.

In some embodiments, the user evaluation request may additionally provide an indication of a third-party product of interest to the user and third-party product information. For example, the user may log into a third-party user account to request rendering of a third-party product or service. By way of particular example, the third-party institution may be a hotel and the user may request a stay at the hotel (e.g., the third-party product). The third-party product information may include information pertaining to the requested third-party product or service. By way of continuing example, the third-party product information may be indicative of a desired length of stay, a number of guests, an estimated cost, etc.

As shown by operation 1004, the apparatus 200 includes means, such as processor 202, memory 204, verification circuitry 210, or the like, for performing a verification routine for the user. In some embodiments, the verification circuitry 210 may perform the verification routine for the user based on the user credentials provided in the user evaluation request. The verification circuitry 210 may perform the verification routine in a substantially similar manner as described in operation 504 of FIG. 5.

As shown by operation 1006, the apparatus 200 includes means, such as processor 202, memory 204, verification circuitry 210, or the like, for determining whether the user was successfully verified. The verification circuitry 210 may determine whether the user was verified based on the outcome of the verification routine performed in operation 1004. The verification circuitry 210 may determine whether the user was verified in a substantially similar manner as described in operation 506 of FIG. 5.

In an instance in which the user fails to be successfully verified, the process proceeds to operation 1008. As shown by operation 1008, the apparatus 200 includes means, such as processor 202, memory 204, communications hardware 206, or the like, for providing an evaluation denial response. In an instance in which the verification circuitry 210 fails to verify the user, the verification circuitry 210 may generate an evaluation denial response indicative that the provided user credentials could not be verified. The communications hardware 206 may provide the evaluation denial response to the requesting third-party device from which the user evaluation request was received. Thus, the third-party institution may be provided with an indication that the user credentials provided by the user did not match the stored user credentials and thus, a user trust score for the user cannot be provided.

In an instance in which the user is successfully verified, the process proceeds to operation 1010. As shown by operation 1010, the apparatus 200 includes means, such as processor 202, memory 204, user evaluation circuitry 216, or the like, for generating a user trust score for the user. As described above, a user trust score may be indicative of the trustworthiness of the user and may further be determined based on the device profiles associated with the user account and the behavior of associated user devices. To generate a user trust score, the user evaluation circuitry 216 may identify the device profiles associated with a user account of the user based on the user credentials (e.g., a user identifier) provided in the user evaluation request. The user evaluation circuitry 215 may analyze the device profiles associated with the user account for various behavioural patterns of the user devices. A user associated with multiple device profiles that are each indicative of consistent behavior (e.g., user account access events) may help establish an improved user trust score as compared to a user associated with fewer device profiles or device profiles indicative of anomalous behavior.

In some embodiments, the user evaluation circuitry 216 may generate a user trust score using a user trust scoring model. The user trust scoring model may be a machine learning model, such as a CNN or RNN, configured to process each device profile associated with the user account, including user account access logs included in the device profile, and identify user device use patterns for each user device. The user trust scoring model may further be configured to compare the device user patterns for each user device to determine a user trust score for the user. A user trust score may indicative of the behavior consistency of a particular user device as well the behavior consistency and/or correlation between multiple user devices, which may be indicative of the trustworthiness of the user. The user trust scoring model may use any suitable techniques for this comparison, such as clustering techniques (e.g., K-nearest neighbors, DBSCAN, affinity propagation, and/or the like), SVMs, etc. In some embodiments, the user trust scoring model may determine the user trust score based on one or more Euclidean distance metrics between various data points corresponding to the various associated user devices.

In some embodiments, the user trust score may further be based on the indication of the third-party product of interest described by the device identity request. For example, the user trust score may be determined based in part on whether a user device associated with the user has previously been used to request the third-party product of interest. In some embodiments, the user trust scoring model may additionally determine whether the third-party product of interest is an anomalous behavior and may include this consideration when determining the user trust score.

Optionally, as shown by operation 1012, the apparatus 200 includes means, such as processor 202, memory 204, communications hardware 206, user evaluation circuitry 216, or the like, for generating one or more product offers for the third-party institution. In some embodiments, the user evaluation circuitry 216 may generate one or more product offers for the third-party institution that may help the third-party institution facilitate the product or service for the user. In particular, the user evaluation circuitry 216 may determine the one or more products of interest based on the current third-party product information indicative of an estimated cost for the third-party product or service and the user trust score. In some embodiments, the user evaluation circuitry 216 may determine whether the user trust score satisfies one or more user trust score thresholds. In an instance in which the user trust score satisfies the user trust score thresholds, the user evaluation circuitry 216 may generate a product offer for the third-party institution that covers at least a portion of the estimated cost of the third-party product or service.

As shown by operation 1014, the apparatus 200 includes means, such as processor 202, memory 204, communications hardware 206, user evaluation circuitry 216, or the like, for providing a user evaluation response. Once the user evaluation circuitry 216 generates a user trust score and optionally, generates one or more product offers for a third-party institution, the user evaluation circuitry 216 may generate a user evaluation response. In some embodiments, the user evaluation response may include the user trust score determined for the user and the one or more product offers determined for the third-party institution. The communications hardware 206 may provide the user evaluation response to the requesting third-party device. Thus, the third-party institution may be provided with a user trust score indicative of an inferred trustworthiness of a user and additionally, one or more available product offers that may be used to facilitate the product or service for the user. This may be particularly beneficial for smaller third-party institutions that lack the resources or technological capabilities to evaluate user trustworthiness by leveraging user devices associated with the user.

### Example User Device Operations

Turning to FIGS. 11-12, example flowcharts are illustrated that contain example operations implemented by example embodiments described herein. The operations illustrated in FIGS. 11-12 may, for example, be performed by any one of user devices 106A-106N shown in FIG. 1, which may in turn be embodied by an apparatus 300, which is shown and described in connection with FIG. 3. To perform the operations described below, the apparatus 200 may utilize one or more of processor 302, memory 304, communications hardware 306, display circuitry 308, analysis circuitry 310, and/or any combination thereof. It will be understood that user interaction with user device 106A-106N may occur directly via communications hardware 306, or may instead be facilitated by a separate device (not shown in FIG. 1), which may have similar or equivalent physical componentry facilitating such user interaction.

Turning first to FIG. 11, example operations are shown for providing a device modification request. Users may use apparatus 300 to view a device trust dashboard, which may contain various device information for the various user devices associated with his/her user account. The user may wish to modify certain device information, such as to correct outdated or incorrect information, modify users associated with the user device, modify authorization rules associated with the user device, and/or the like. Thus, the user may interact with the device trust dashboard to request these modifications and apparatus 300 may provide a device modification request responsive to these requested changes. The device trust dashboard may then be updated accordingly and displayed to the user via the apparatus 300.

As shown by operation 1102, the apparatus 300 includes means, such as processor 302, memory 304, communications hardware 306, display circuitry 308, or the like, for determining a device trust dashboard request. The device trust dashboard request may be indicative of a request for apparatus to access a device trust dashboard for the user. The device trust dashboard request may include user credentials as input by a user. In some embodiments, the user credentials may include a user identifier (e.g., a username, email address, and/or the like) and a password (e.g., PIN, biometric data, text password, and/or the like).

Apparatus 300 may determine a device trust dashboard request via user interaction with a mobile application or web application rendered by display circuitry 308. For example, a user may open a mobile application or web application that is associated with a device trust dashboard. The display circuitry 308 may be configured to render a login screen for the associated mobile application or web application. The communications hardware 306 may then receive user credentials input by the user. The communications hardware 306 may then provide the device trust dashboard request to management device 110 as described below in operation 1104.

As shown by operation 1104, the apparatus 300 includes means, such as processor 302, memory 304, communications hardware 306, or the like, for providing the device trust dashboard request. Once the communications hardware 306 receives the user credentials input by the user, the communications hardware 306 may provide the device trust dashboard request to management device 110. The communications hardware 306 may provide the device trust dashboard request using a HTTP or HTTPS protocols. In some embodiments, the device trust dashboard request may include the “GET” HTTP header. In some embodiments, the communications hardware 306 may use various APIs, such as WebSocket, or RESTful APIs, to communicate with management device 110. In some embodiments, the HTTP header of the device trust dashboard request may include a ‘user-agent’ header indicative of the type of device of apparatus 300 and the browser or application used by apparatus 300.

As shown by operation 1106, the apparatus 300 includes means, such as processor 302, memory 304, communications hardware 306, or the like, for receiving a device trust dashboard. In an instance in which the user is successfully verified, the communications hardware 306 may receive the device trust dashboard from management device 110. The received device trust dashboard may include user account information and device profile information for the device profiles associated with the user account. The device trust dashboard may include various components representative of a device profile for each device profile associated with the user account. A device profile may include a representation of select device information (e.g., a device name, a device phone number, and/or the like), a device classification, a device trust score, and an authorization rule set. The device trust dashboard may further include one or more interaction elements that allow a user to interact with the device trust dashboard and/or a device profile to view additional information of the device profile for a user device, request a device profile be modified, request a device trust score for a user device be improved, remove a device profile from the device trust dashboard, add a new user device, view a user account access log, temporarily transfer a device trust score, and/or the like. These interaction elements may allow a user to interact with them (e.g., touch, select, click, audibly select, and/or the like) to proceed with a corresponding interaction operation. In some embodiments, the received device trust dashboard may include instructions for rendering the device trust dashboard on a display associated with apparatus 300.

In some embodiments, the communications hardware 306 may receive the device trust dashboard using HTTP or HTTPS protocols, such as via a “POST” method with an appropriate HTTP header. As another example, the communications hardware 306 may use specific APIs, such as RESTful APIs or WebSocket APIs to receive the device trust dashboard from the management device 110.

As shown by operation 1108, the apparatus 300 includes means, such as processor 302, memory 304, display circuitry 308, or the like, for displaying the device trust dashboard. The display circuitry 308 may be configured to render display of the device trust dashboard based on the provided instructions. In some embodiments, the instructions may include instructions for rendering a main device trust dashboard interface on an associated display. Additionally, in some embodiments, the instructions may include instructions for rendering a device modification interface on an associated display in response to detection of user interaction with one or more interaction elements of the device trust dashboard.

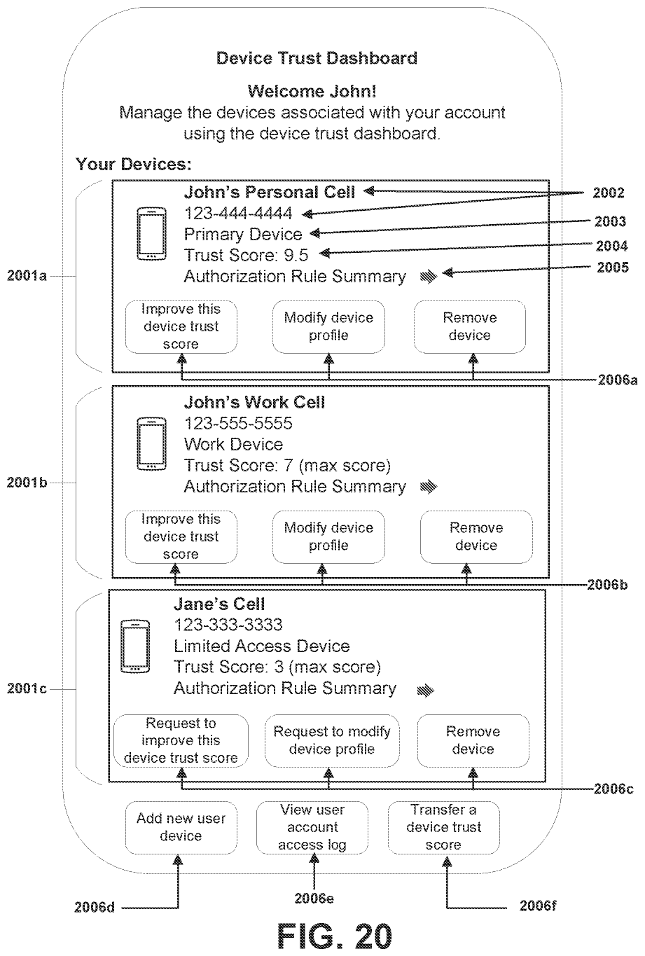

Turning to FIG. 20, a graphical user interface (GUI) is provided that illustrates an example of a main device trust dashboard interface as displayed to a user. As noted previously, a user may interact with the device management system 102 by directly engaging with communications hardware 206 of an apparatus 200 comprising a management device 110 of the device management system 102. In such an embodiment, the GUI shown in FIG. 20 may be displayed to a user by the apparatus 200. Alternatively, a user may interact with the device management system 102 using a separate user device (e.g., any one of user devices 106A-106N, as shown in FIG. 1), which may communicate with the device management system 102 via communications network 104. In such an embodiment, the GUI shown in FIG. 20 may be displayed to the user by a user device, such as apparatus 300.

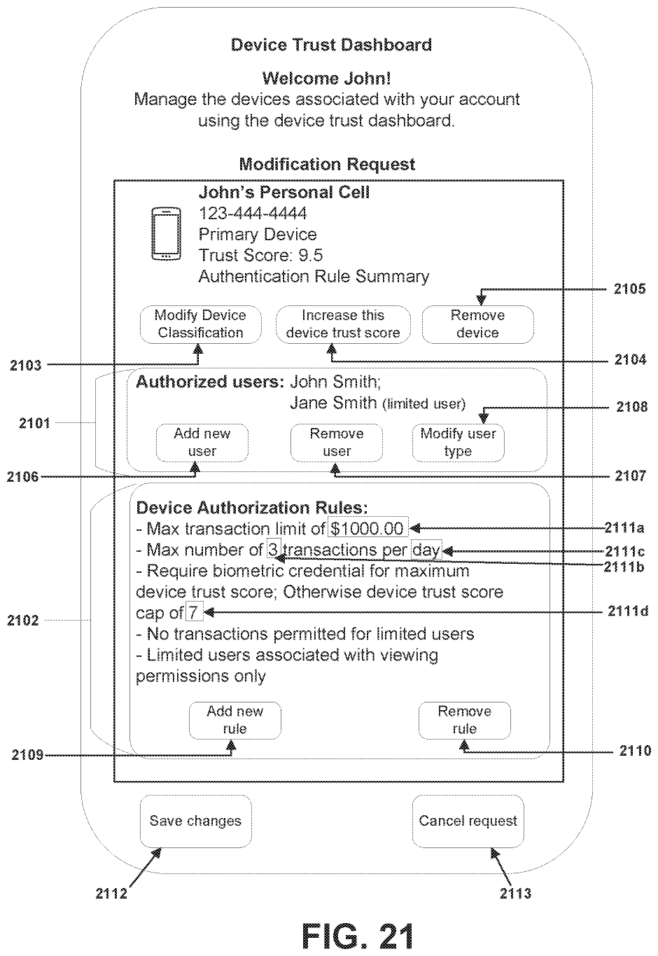

As shown in FIG. 20, a device trust dashboard may include one or more device profiles 2001a, 2001b, and 2001c, each corresponding to a user device associated with the user account of the user. Within each device profile, the device trust dashboard may further include a representation of select device information 2002, a device classification 2003, a device trust score 2004, and an authorization rule set 2005. Thus, the user may view each individual device profile to identify relevant information pertaining to the particular user device. Additionally, the device trust dashboard may include one or more interaction elements 2006a, 2006b, 2006c, 2006d, 2006e, and 2006f that a user may interact with. Each interaction element may cause a particular action to be performed. For example, selection of the “add a new user device” interaction element 2006d may cause communications hardware 306 to provide a new device request to the management device 110. As another example, selection of the “view user account access log” interaction element 2006e may cause display circuitry 308 to render the user account access log associated with the user account. As another example, selection of the “transfer a device trust score” interaction element 2006f may cause the communications hardware 306 to provide a transfer request to the management device 110. As another example, selection of the “improve this trust score” interaction element may cause the communications hardware 306 to provide a device trust improvement request to the management device 110. As another example, selection of the “remove device” interaction element may cause the communications hardware 306 to provide an indication to remove the device profile and user device association with the user account to the management device 110. The device management circuitry 208 may then determine the remove the association of the device profile with the user account. As another example, selection of the “request to improve this device trust score” interaction element may be available in an instance in which the user is listed as a limited user on another user account (e.g., a primary user). This may cause the communications hardware 306 to provide a trust improvement event request to management device 110. As another example, selection of the “request to modify device profile” interaction element may be available in an instance in which the user is listed as a limited user on another user account (e.g., a primary user). This may cause the communications hardware 306 to provide a request to management device 110 indicative of a requested modification for the user profile. The management device 110 may relay this request to the primary user via an associated user device, who may then authorize or deny the request. In some embodiments, interaction with one or more of the interaction elements in the device trust dashboard may cause the display circuitry 308 to render a device modification interface, as shown in FIG. 21.

Turning now to FIG. 21, a GUI is provided that illustrates a device modification interface within the device trust dashboard. As noted previously, a user may interact with the device management system 102 by directly engaging with communications hardware 206 of an apparatus 200 comprising a management device 110 of the device management system 102. In such an embodiment, the GUI shown in FIG. 21 may be displayed to a user by the apparatus 200. Alternatively, a user may interact with the device management system 102 using a separate user device (e.g., any one of user devices 106A-106N, as shown in FIG. 1), which may communicate with the device management system 102 via communications network 104. In such an embodiment, the GUI shown in FIG. 21 may be displayed to the user by a user device, such as apparatus 300.

As shown in FIG. 21, the device modification interface within a device trust dashboard may pertain to a particular user device (e.g., John's Personal Cell). The device modification interface may allow a user to provide the analysis circuitry 310 with one or more requested device modifications for the user device by interaction with various interaction elements. For example, the device modification interface may allow a user to modify a device classification for the user device through interaction with interaction element 2103. The device modification interface may also allow a user to remove the user device as associated with the user profile through interaction with interaction element 2104 to request the user device's association with the user account be removed.

The device modification interface may also include an indication of the users associated with the user device 2101 as defined in the authorization rule set. The device modification interface may allow a user to add a new user to be associated with the user device (e.g., a new limited user) by interacting with interaction element 2106, remove a particular user (e.g., remove a limited user) by interacting with interaction element 2107, or modifying a user type for a user by interacting with interaction element 2108.

The device modification interface may also include an indication of the authorization rules of the authorization rule set 2102. The device modification interface may allow a user to add a new authorization rule by interacting with interaction element 2109, remove a particular authorization rule by interacting with interaction element 2110, or modifying a value for an authorization rule by interacting with interaction elements 2111a, 2111b, 2111c, or 2111d.

The device modification interface may allow a user to submit the requested changes or modification by interacting with interaction element 2112, which may cause a device modification request to be provided to the management device 110. The device modification interface may allow a user to cancel requested changes or modification by interacting with interaction element 2113, which may cause the display to return to a main device trust dashboard interface, as depicted in FIG. 20.

The device modification interface may also allow a user to provide an indication requesting an increase of the device trust score for the user device through interaction with interaction element 2104. In some embodiments, in an instance in which the user interacts with interaction element 2104, the device modification interface may cause a device trust improvement request to be provided to the management device 110, in addition to or in lieu of the device modification request.

Returning now to FIG. 11, as shown by operation 1110, the apparatus 300 includes means, such as processor 302, memory 304, communications hardware 306, display circuitry 308, analysis circuitry 310, or the like, for determining a requested modification to a device profile of a user device within the device trust dashboard. In some embodiments, the analysis circuitry 310 may be configured to detect user interaction (e.g., click, touch, audibly select, or the like) from the user with an interaction element of the device trust dashboard that is associated with a request for modification to a device profile for a particular user device. For example, referring back to FIG. 20, the user may select the “modify device profile” interaction element 2006a to request a modification to the device profile 2001a.

In some embodiments, in an instance in which the analysis circuitry 310 determines a requested modification to the device profile, the display circuitry 308 may be configured to display a device modification interface, such as the device modification interface depicted in FIG. 21. The analysis circuitry 310 may then determine the particular requested modification for the device profile based on received user input within the device modification interface. In some embodiments, the display circuitry 308 may be configured to display a list of predefined values (e.g., predefined device classifications, predefined authorization rules, currently associated limited users, or the like) in the device modification interface, which may be described by the received instructions. As such, the user may be presented with a limited number of choices that correspond to predefined values configured by device management system 102.

As shown by operation 1112, the apparatus 300 includes means, such as processor 302, memory 304, communications hardware 306, analysis circuitry 310 or the like, for providing a device modification request. Once the analysis circuitry 310 determines the one or more requested modifications to the device profile, the analysis circuitry 310 may generate the device modification request. The device modification request pertains to a particular user device, which may be user device 106A or another user device associated with the user account (e.g., any one of user devices 106B-106N). In some embodiments, the device modification request may be indicative of a request to modify a device classification for the user device or modify an authorization rule set for the user device. The device modification request may be indicative of a request to modify a device classification or an authorization rule set for a user device. The device modification may additionally include the one or more updates values, an indication of a new requested authorization rules, an indication of a request for removal of an authorization rule, a request to add a new limited user, a request to remove a limited user, and/or the like.

In some embodiments, the communications hardware 306 may provide the device modification request to management device 110 using HTTP or HTTPS protocols, such as via a “POST” method with an appropriate HTTP header. As another example, the communications hardware 306 may use specific APIs, such as RESTful APIs or WebSocket APIs to provide the device modification request to the management device 110.

As shown by operation 1114, the apparatus 300 includes means, such as processor 302, memory 304, communications hardware 306, or the like, for receiving an updated device trust dashboard. In some embodiments, the communications hardware 306 may receive an updated device trust dashboard that may reflect the modifications to the user device as requested by the user in the device modification request. The updated device trust dashboard may include instructions for rendering the updated device trust dashboard on an associated display. In some embodiments, the communications hardware 306 may receive the updated device trust dashboard from management device 110 using HTTP or HTTPS protocols, such as via a “POST” method with an appropriate HTTP header. As another example, the communications hardware 306 may use specific APIs, such as RESTful APIs or WebSocket APIs to receive the updated device trust dashboard from the management device 110.

As shown by operation 1116, the apparatus 300 includes means, such as processor 302, memory 304, communications hardware 306, display circuitry 308, or the like, for displaying the updated device trust dashboard. The display circuitry 308 may be configured to render display of the updated device trust dashboard based on the provided instructions. The display circuitry 308 may be configured to display the updated device trust dashboard in a manner similarly to the operations described in operation 1108.

Turning now to FIG. 12, example operations are shown for providing a trust improvement request. As described above, users may use apparatus 300 to view a device trust dashboard, which may contain various device information for the various user devices associated with his/her user account. The user may view a device trust score for an associated user device and may wish to improve the current device trust score. Thus, the user may interact with the device trust dashboard to request a trust improvement event and apparatus 300 may provide a device trust improvement request.

As shown by operation 1202, the apparatus 300 includes means, such as processor 302, memory 304, communications hardware 306, display circuitry 308, analysis circuitry 310 or the like, for determining a device trust dashboard request. The device trust dashboard request may be indicative of a request for apparatus to access a device trust dashboard for the user. The device trust dashboard request may be determined in a substantially similar manner as described in operation 1102.

As shown by operation 1204, the apparatus 300 includes means, such as processor 302, memory 304, communications hardware 306, or the like, for providing the device trust dashboard request. The device trust dashboard request may be provided to a management device 110 in a substantially similar manner as described in operation 1104.

As shown by operation 1206, the apparatus 300 includes means, such as processor 302, memory 304, communications hardware 306, or the like, for receiving a device trust dashboard. The device trust dashboard may be received from a management device 110 in a substantially similar manner as described in operation 1106.

As shown by operation 1208, the apparatus 300 includes means, such as processor 302, memory 304, display circuitry 308, or the like, for displaying the device trust dashboard. The device trust dashboard request may be displayed in a substantially similar manner as described in operation 1108.

As shown by operation 1210, the apparatus 300 includes means, such as processor 302, memory 304, communications hardware 306, display circuitry 308, analysis circuitry 310, or the like, for determining a requested improvement to a device trust score for a user device within the device trust dashboard. In some embodiments, the analysis circuitry 310 may be configured to detect user interaction (e.g., click, touch, audibly select, or the like) from the user with an interaction element of the device trust dashboard that is associated with a request to improve a device trust score for a for a particular user device. For example, referring back to FIG. 20, the user may select the “improved this device trust score” interaction element 2006a to request that the device trust score of the user device associated with device profile 2001a be improved. In some embodiments, the user device for which the user requested improvement to the device trust score corresponds to apparatus 300. In some embodiments, the user device for which the user requested improvement to the device trust score does not correspond to apparatus 300 and may be another user device associated with the user account.

In some embodiments, in an instance in which the analysis circuitry 310 determines a requested improvement to a device trust score, the display circuitry 308 may be configured to display a device modification interface, such as the device modification interface depicted in FIG. 21. The analysis circuitry 310 may determine a target device trust score for the user device. In some embodiments, the display circuitry 308 may be configured to display a range of possible or attainable device trust score values. As such, the user may be presented with valid choices for a device trust score when selecting target device trust score.

As shown by operation 1212, the apparatus 300 includes means, such as processor 302, memory 304, communications hardware 306, or the like, for providing a device trust improvement event. Once the analysis circuitry 310 determines the requested improvement to the device trust score for the user device, the analysis circuitry 310 may generate the device trust improvement request. The device trust improvement request pertains to a particular user device and may further include the target device trust score.

In some embodiments, the communications hardware 306 may provide the device trust improvement request to management device 110 using HTTP or HTTPS protocols, such as via a “POST” method with an appropriate HTTP header. As another example, the communications hardware 306 may use specific APIs, such as RESTful APIs or WebSocket APIs to provide the device trust improvement request to the management device 110.

As shown by operation 1214, the apparatus 300 includes means, such as processor 302, memory 304, communications hardware 306, or the like, for receiving a trust improvement event. In some embodiments, the communications hardware 306 may receive a trust improvement event from the management device 110. The trust improvement event may describe one or more operations that may be executed or performed by a user and/or apparatus 300 to improve the device trust score for a requested user device. Additionally, the trust improvement event may be describe an assigned performance time window that is indicative of an amount of time for which the trust improvement event is valid for.

The trust improvement event may include executable software instructions for rendering the trust improvement event on an associated display. In some embodiments, the communications hardware 306 may receive the trust improvement event from management device 110 using HTTP or HTTPS protocols, such as via a “POST” method with an appropriate HTTP header. As another example, the communications hardware 306 may use specific APIs, such as RESTful APIs or WebSocket APIs to receive the updated device trust dashboard from the management device 110. In some embodiments, the communications hardware 306 may receive the trust improvement event through a communication channel outside of the device trust dashboard, such as via short-message service text, email, and/or the like.

As shown by operation 1216, the apparatus 300 includes means, such as processor 302, memory 304, communications hardware 306, display circuitry 308, or the like, for displaying the trust improvement event. The display circuitry 308 may be configured to render display of the trust improvement event. In some embodiments, the software executable instructions may include instructions for rendering a trust improvement event interface on an associated display. The trust improvement event interface may display the one or more operations associated for the trust improvement event that the user and/or user device is required to perform. Thus, the user may view the operations and instructions to perform to result in the improved device trust score for the user device.

Optionally, as shown by operation 1218, the apparatus 300 includes means, such as processor 302, memory 304, communications hardware 306, display circuitry 308, analysis circuitry 310, or the like, for performing a trust improvement event. As described above, in some embodiments, the user device for which the user requested improvement to the device trust score corresponds to apparatus 300. Thus, apparatus 300 may execute one or more operations described by the trust improvement event such that the trust improvement even may be performed completely.

For example, the trust improvement event includes an instruction to perform an action at one or more candidate ATMs using apparatus. Thus, in some embodiments, the communications hardware 306, display circuitry 308, and/or analysis circuitry 310 may be configured to receive user input to pre-stage an ATM operation for a candidate ATM using a mobile application or web application, perform an operation at a candidate ATM using NFC or Bluetooth, scan a QR code displayed on a candidate ATM, and/or the like.

As another example, the trust improvement event includes an instruction to to perform a transaction at one or more candidate merchants. Thus, in some embodiments, the communications hardware 306, display circuitry 308, and/or analysis circuitry 310 may be configured to receive user input to perform a transaction at a point-of-sale terminal of a candidate merchant using the user device 106N (e.g., via Bluetooth, NFC) such as by using a mobile wallet and/or the like.

As another example, the trust improvement event includes an instruction to perform an authentication routine at one or more candidate institution locations. Thus, in some embodiments, the communications hardware 306, display circuitry 308, and/or analysis circuitry 310 may be configured to receive user input to display requested user information.

As another example, the trust improvement event includes an instruction to provide a received OTP in response to receiving an OTP. Thus, in some embodiments, the communications hardware 306, display circuitry 308, and/or analysis circuitry 310 may be configured to receive an OTP from the management device 110 and receive user input to provide the OTP back to the management device 110.

As another example, the trust improvement event includes an instruction to provide a selfie request. In some embodiments, the selfie request may require a captured image of the user's face. Thus, in some embodiments, the communications hardware 306, display circuitry 308, and/or analysis circuitry 310 may be configured to receive user input to capture an image (e.g., via an associated camera) and provide the captured image to the management device 110.

FIGS. 4-12 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

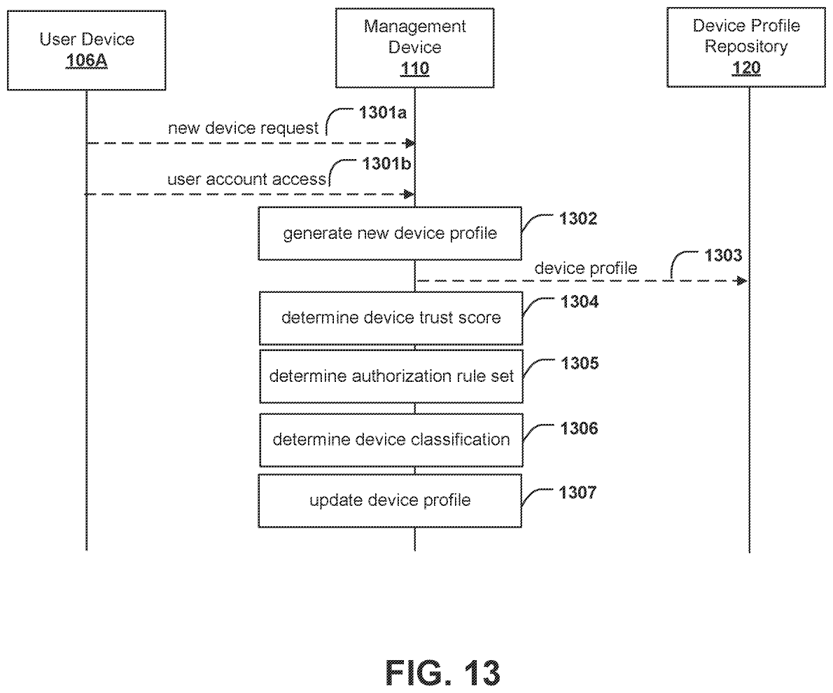

FIGS. 13-19 show swim lane diagrams illustrating example operations (e.g., as described above in connection with FIGS. 4-12) performed by components of the environment depicted in FIG. 1 to produce various benefits of the implementations described herein. The operations shown in the swim lane diagram performed by user device 106A are shown along the line extending from the box labeled “user device 106A,” operations performed by a management device 110 are shown along the line extending from the box labeled “management device 110,” operations performed by a device profile repository 120 are shown along the line extending from the box labeled “device profile repository 120,” operations performed by a user device 106N are shown along the line extending from the box labeled “user device 106N” (where user device 106N may be the same user device as user device 106A or may be a different user device), operations performed by a user device 106B are shown along the line extending from the box labeled “user device 106B,” and operations performed by a third-party device 108A are shown along the line extending from the box labeled “third-party device 108A.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 13-19.

Turning first to FIG. 13, operations are shown for generating a device profile for a new user device. Optionally, at operation 1301a, user device 106A may provide a new device request to the management device 110. It will be appreciated that the new device request may pertain to user device 106A or another user device, such as user device 106B. Alternatively, at operation 1301b, user device 106A may access a user account that is detected by management device 110. In either instance, the management device 110 may then determine whether the user device to which the new device request pertains or that accessed the user account is currently associated with a device profile. In an instance in which the management device 110 determines the user device of interest is not currently associated with a device profile, at operation 1302, the management device 110 may generate a new device profile for the user device of interest (e.g., by way of continuing example, user device 106A or user device 106B). Optionally, at operation 1303, the management device 110 may provide the device profile to the device profile repository 120 for storage. At operation 1304, the management device 110 may determine the device trust score for the user device of interest. At operation 1305, the management device 110 may determine the authorization rule set for the user device of interest. At operation 1306, the management device 110 may determine the device classification for the user device of interest. At operation 1307, the management device 110 may update the device profile for the user device of interest based on the determined device trust score, authorization rule set, and device classification. The management device 110 may access the device profile stored in the device profile repository 120 to update the stored device profile.

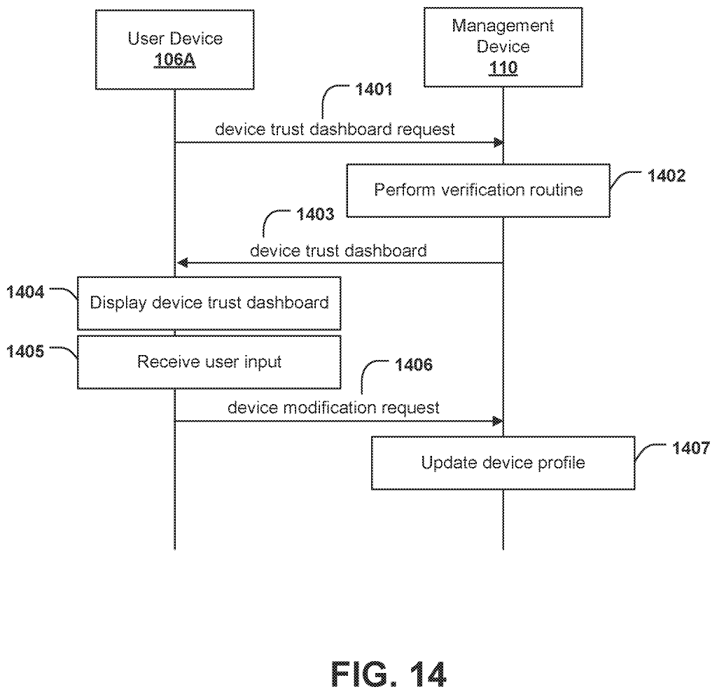

Turning now to FIG. 14, operations are shown for modifying a device profile for a user device. At operation 1401, user device 106A may provide a device trust dashboard request to the management device 110. The device trust dashboard request may include user credentials. At operation 1402, the management device 110 may perform a verification routine to verify user device 106A using the provided user credentials. At operation 1403, the management device 110 may provide a device trust dashboard to the user device 106A in an instance in which the user is successfully authenticated. At operation 1404, the user device 106A may display the device trust dashboard. At operation 1405, the user device 106A may receive user input. The received user input may be indicative of one or more requested modifications to a device profile. At operation 1406, the user device 106A may provide a device modification request indicative of the requested modifications to the management device 110. At operation 1407, the management device 110 may update the device profile to reflect the requested modifications in an instance in which the user device 106A is determined to be authorized to request such modifications.

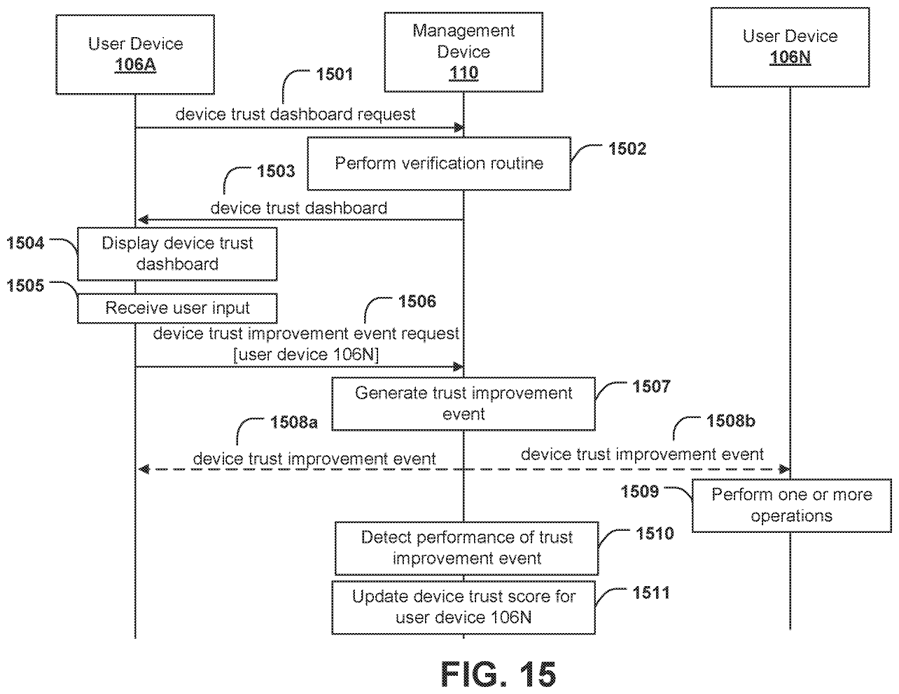

Turning now to FIG. 15, operations are shown for improving a device trust score for a user device 106N. At operation 1501, user device 106A may provide a device trust dashboard request to the management device 110. The device trust dashboard request may include user credentials. At operation 1502, the management device 110 may perform a verification routine to verify user device 106A using the provided user credentials. At operation 1503, the management device 110 may provide a device trust dashboard to the user device 106A in an instance in which the user is successfully authenticated. At operation 1504, the user device 106A may display the device trust dashboard. At operation 1505, the user device 106A may receive user input. The received user input may be indicative of a request to improve a device trust score for user device 106N. At operation 1506, the user device 106A may provide a device trust improvement event request indicative of a request to improve the device trust score of user device 106N. At operation 1507, the management device 110 may generate a trust improvement event for the user device 106N. At operations 1508a and 1508, the management device 110 may provide the device trust improvement event to the user device 106A and/or user device 106N. At operation 1509, the user device 106N may perform one or more operations described by the trust improvement event. At operation 1510, the management device 110 may detect that the user device 106N has performed the trust improvement event. At operation 1511, the management device 110 may update the device trust score for the user device 106N in response to detecting performance of the trust improvement event.

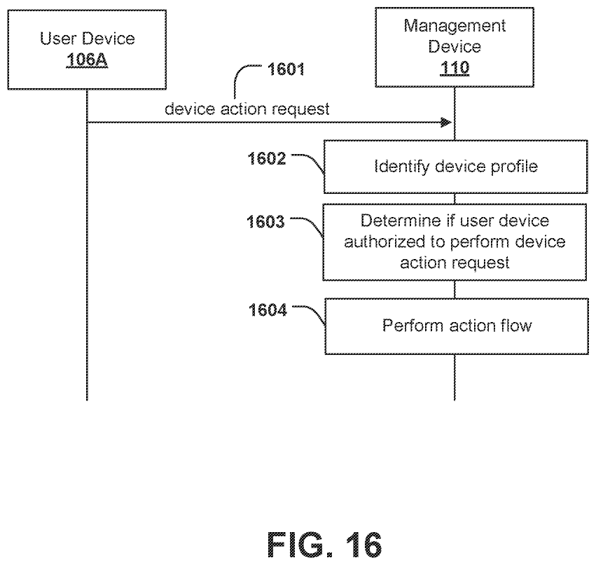

Turning now to FIG. 16, operations are shown for facilitating a device action request for user device 106A. At operation 1601, user device 106A may provide a device action request to management device 110. The device action request may include an action request type and request information. At operation 1602, the management device 110 may identify the device profile for the user device 106A. At operation 1603, the management device 110 may determine whether user device 106A is authorized to perform the device action request. At operation 1604, in an instance in which the user device 106A is authorized to perform the device action request, the management device 110 may perform an action flow associated with the action request type.

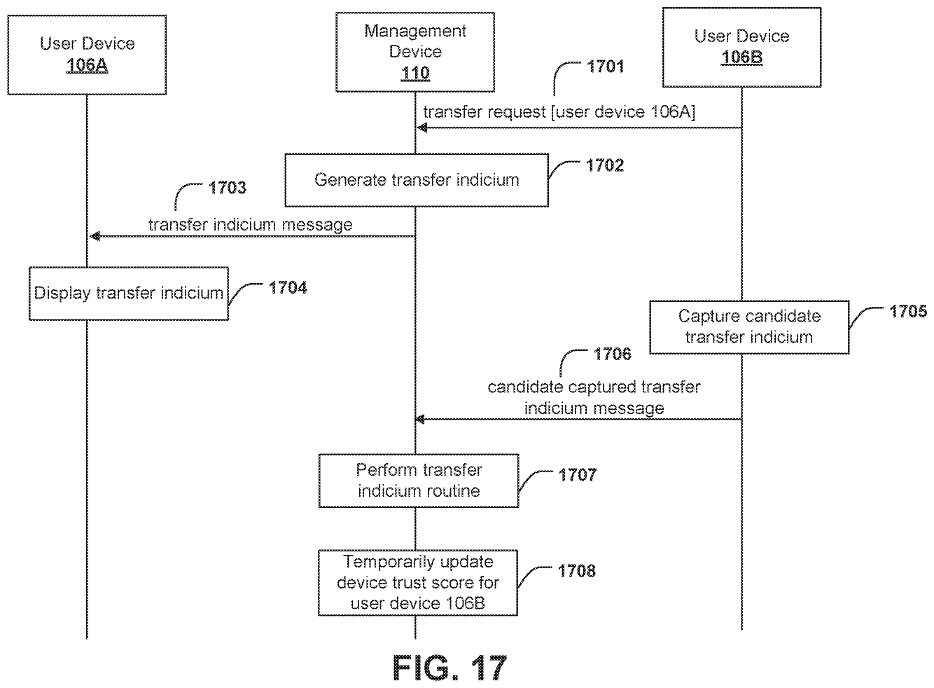

Turning now to FIG. 17, operations are shown for facilitating a transfer indicium routine. At operation 1701, user device 106B may provide a transfer request to management device 110. The transfer request may be indicative of a request to use the device trust score of user device 106A. At operation 1702, the management device 110 may generate transfer indicium. At operation 1703, the management device 110 may provide a transfer indicium message that includes the transfer indicium to the user device 106A. At operation 1704, the user device 106A may display the transfer indicium using an associated display. At operation 1705, the user device 106B may capture candidate transfer indicium, such as by using an associated camera to take an image of the transfer indicium displayed by the user device 106A. At operation 1706, the user device 106B may provide a candidate captured transfer indicium message to the management device 110. The captured transfer indicium message may include the captured candidate transfer indicium. At operation 1707, the management device may perform a transfer indicium routine based on the original transfer indicium and the received candidate transfer indicium to generate a match likelihood score. At operation 1708, in an instance in which the match likelihood score satisfies a match likelihood score threshold, the management device 110 may update a device score for user device 106B by assigning a value of a device trust score for user device 106B that is equivalent to the device trust score for user device 106A for a limited duration.

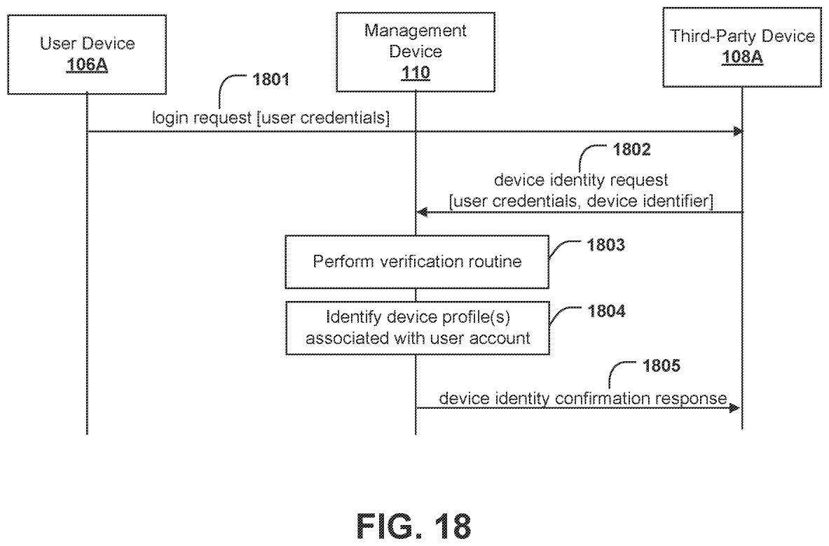

Turning now to FIG. 18, operations are shown for facilitating a device identity request for a third-party device 108A. At operation 1801, a user device 106A may provide a login request to a third-party device 108A. The login request may include user credentials that are associated with the management device 110. At operation 1802, the third-party device 108A may provide a device identity request to management device 110. The device identity request may include user credentials that were included in the login request and/or a device identifier corresponding to user device 106A. At operation 1803, the management device 110 may perform a verification routine. At operation 1804, in an instance in which the user was successfully verified, the management device 110 may identify one or more device profiles associated with the user account, including the device profile of user device 106A. At operation 1805, the management device 110 may provide a device identity confirmation response to the third-party device 108A. The device identity confirmation response may include the device trust scores for the one or more user devices, including the device trust score of user device 106A.

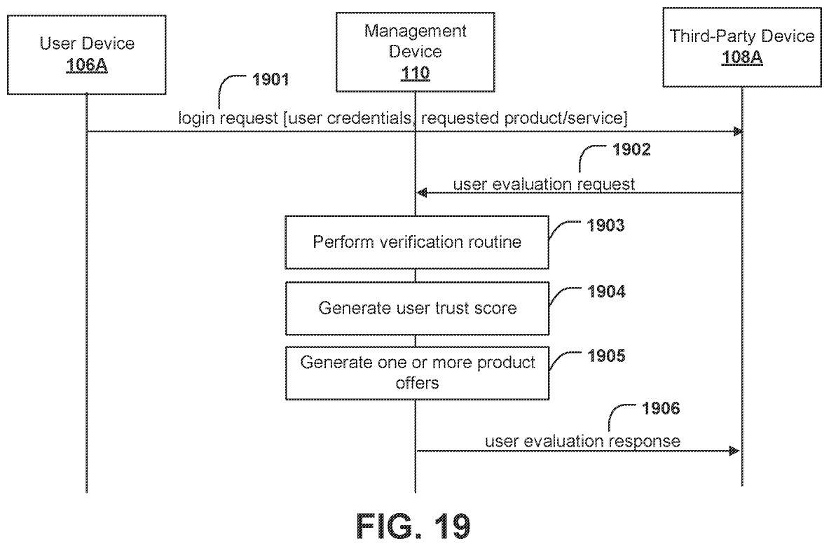

Turning now to FIG. 19, operations are shown for facilitating a user evaluation request for a third-party device 108A. At operation 1901, a user device 106A may provide a login request to a third-party device 108A and the login request may further be indicative of a requested product or service offered by a third-party institution associated with the third-party device 108A. The login request may include user credentials that are associated with the management device 110. At operation 1902, the third-party device 108A may provide a user evaluation request to management device 110. The user evaluation request may include user credentials that were included in the login request and/or an indication of the requested product or service. At operation 1903, the management device 110 may perform a verification routine. At operation 1904, in an instance in which the user was successfully verified, the management device 110 may generate a user trust score for the user. At operation 1905, the management device 110 may generate one or more product offers for the third-party institution to help facilitate the requested third-party product or service for the user. At operation 1906, the management device 110 may provide a user evaluation response to the third-party device 108A. The user evaluation response may include the user trust score and the one or more product offers.

In some embodiments, some of the operations described above in connection with FIGS. 4-12 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved visibility and control over user devices associated with a user account. Example embodiments thus provide tools that allow users to manage user devices associated with their user accounts in a manner not traditionally available. In particular, device profiles for user devices associated with the user may be generated and maintained based on user device interaction with the user account. Users may use the device trust dashboard to view the device information for various associated user devices and gain insights that were not previously available. This may help users manage the user devices that are accessing their user accounts, which may be particular beneficial for user devices which are not frequently interacted with by the user but may be linked or have previously been used to interact with the user account, such as smart televisions, smart fridges, smart home assistants, smart cars, and/or other IoT devices.

Additionally, the device trust dashboard enables users to use their user devices in a non-traditional manner. For example, a user may use the device trust dashboard to request a transfer request indicative of a request to temporarily transfer a device trust score of a first user device to the second user device. By leveraging the robust device information included in the device profile, the transfer request allows for a conventionally unavailable interaction between user devices for the benefit of the user while maintaining security of the user account.

Furthermore, the device trust dashboard allows users to leverage the associated device profiles managed by the system for use with institutions other than the institution associated with the user account. For example, third-party institutions may be provided with user device information and/or a user trust score if so requested or authorized by the user. This may additionally aid third-party institutions that lack the capabilities or technology to determine a device trust score by simply providing the device trust score to said third-party institutions that would ordinarily not be available to them.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing a device trust dashboard, the method comprising:
generating, by device management circuitry, a device profile for a first user device associated with a user account of a user;
determining, by the device management circuitry and based on a device feature set associated with the first user device, a device trust score for the first user device;
determining, by the device management circuitry and based on the device trust score and a user preference set associated with the user, an authorization rule set for the first user device;
updating, by the device management circuitry, the device profile for the first user device to comprise the device trust score for the first user device and the authorization rule set for the first user device;
receiving, by communications hardware, a device trust dashboard request, wherein the device trust dashboard request comprises candidate user credentials;
performing, by verification circuitry and based on the received candidate user credentials, a verification routine for the user; and
in an instance in which the user is successfully verified, providing, by the communications hardware, the device trust dashboard, wherein the device trust dashboard comprises at least a representation of the device profile for the first user device.

2. The method of claim 1, further comprising:
receiving, by the communications hardware and via the device trust dashboard, a device trust improvement request, wherein the device trust improvement request is associated with the first user device;
generating, by the device management circuitry, a trust improvement event, wherein the trust improvement event comprises one or more operations to improve the device trust score for the first user device;
providing, by the communications hardware, the trust improvement event;
detecting, by the device management circuitry, performance of the trust improvement event; and
updating, by the device management circuitry and based on the performance of the trust improvement event, the device trust score in the device profile for the first user device.

3. The method of claim 2, further comprising:
determining, by the device management circuitry, one or more candidate automated teller machines (ATMs), wherein the trust improvement event includes an instruction to perform an action at one of the one or more candidate ATMs using the first user device;
detecting, by the device management circuitry, performance of the action at one of the one or more candidate ATMs by the first user device; and
updating, by the device management circuitry, the device trust score in the device profile for the first user device.

4. The method of claim 2, further comprising:
determining, by the device management circuitry, one or more candidate merchants, wherein the trust improvement event includes an instruction to perform a transaction at one of the one or more candidate merchants using the first user device;
detecting, by the device management circuitry, performance of the transaction at one of the one or more candidate merchants by the first user device; and
updating, by the device management circuitry, the device trust score in the device profile for the first user device.

5. The method of claim 2, further comprising:
determining, by the device management circuitry, one or more candidate institution locations, wherein the trust improvement event includes an instruction to visit one of the one or more candidate institution locations and perform an authentication routine using the first user device;
detecting, by the device management circuitry, performance of the authentication routine by the first user device; and
updating, by the device management circuitry, the device trust score in the device profile for the first user device.

6. The method of claim 2, further comprising:
generating, by the device management circuitry, a one-time passcode, wherein the trust improvement event includes an instruction to provide a received one-time passcode;
providing, by the communications hardware, the one-time passcode to the first user device;
receiving, by the communications hardware, a candidate one-time passcode from the first user device;
performing, by the device management circuitry and based on the generated one-time passcode, an authentication routine to authenticate the candidate one-time passcode;
in in an instance in which the candidate one-time passcode is successfully authenticated, updating, by the device management circuitry, the device trust score in the device profile for the first user device.

7. The method of claim 2, further comprising:
providing, by the communications hardware, a selfie request to the first user device, wherein the trust improvement event comprises the selfie request;
receiving, by the communications hardware, a selfie response from the first user device, wherein the selfie response includes a candidate captured image;
determining, by the device management circuitry, whether a biometric match is determined for the candidate captured image based on a comparison of the candidate captured image with one or more authenticated user images associated with the user account; and
in in an instance in which a biometric match is determined, updating, by the device management circuitry, the device trust score in the device profile for the first user device.

8. The method of claim 1, further comprising determining, by the device management circuitry and based on the user preference set associated with the user, a device classification for the first user device, wherein the device profile further comprises the device classification for the first user device.

9. The method of claim 1, further comprising:
receiving, by the communications hardware and via the device trust dashboard, a device modification request, wherein (a) the device modification request pertains to the first user device and (b) the device modification request corresponds to a request (i) to modify a device classification for the first user device or (ii) modify the authorization rule set for the first user device; and
updating, by the device management circuitry and based on the device modification request, the device profile corresponding to the first user device.

10. The method of claim 1, further comprising:
monitoring, by device identification circuitry, for a user account access event within the user account; and
generating, by the device identification circuitry, a user account access log, wherein (a) the user account access log is indicative of a device associated with the user account access event and a timestamp of the user account access event and (b) the device trust dashboard comprises the user account access log.

11. The method of claim 1, further comprising:
receiving, by the communications hardware, a device action request from the first user device, wherein the device action request comprises an action request type and request information;
identifying, by operations circuitry, the device trust score and the authorization rule set for the first user device within the device profile of the device trust dashboard;
determining, by the operations circuitry and based on the device trust score and the authorization rule set for the first user device, whether the first user device is authorized to perform the device action request; and
in an instance in which the first user device is successfully authorized to perform the device action request, performing, by the operations circuitry and based on the request information, an action flow that corresponds to the action request type.

12. The method of claim 11, further comprising in an instance in which the first user device is fails to be authorized to perform the device action request, providing, by the communications hardware, an action denial response to the first user device, wherein the action denial response is indicative of a reason for an authorization failure of the first user device.

13. The method of claim 1, further comprising:
receiving, by the communications hardware and via the device trust dashboard, a new device request, wherein the new device request is indicative of a second user device to be associated with the user account;
generating, by the device management circuitry, a user device profile for the second user device;
determining, by the device management circuitry and based on a device feature set associated with the second user device, a device trust score for the second user device;
determining, by the device management circuitry and based on the device trust score and the user preference set associated with the user, an authorization rule set for the second user device; and
updating, by the device management circuitry, the user device profile for the second user device to comprise the device trust score for the second user device and the authorization rule set for the second user device, wherein the device trust dashboard comprises at least a representation of the device profile for the first user device and a representation of the device profile for the second user device.

14. The method of claim 1, further comprising:
receiving, by the communications hardware and via the device trust dashboard, a transfer request from a second user device, wherein the transfer request is indicative of a request to transfer a device trust score transfer from the first user device to the second user device;
providing, by the communications hardware, a transfer indicium message to the first user device, wherein the transfer indicium message comprises instructions for rendering a transfer indicium on the first user device;
receiving, by the communications hardware, a candidate captured transfer indicium message from the second user device, wherein the candidate captured transfer indicium message comprises a captured image depicting a candidate transfer indicium;
performing, by the verification circuitry, a transfer indicium routine, wherein the transfer indicium routine generates an match likelihood score based on a comparison of the candidate transfer indicium with the transfer indicium; and
in an instance in which the match likelihood score satisfies a match likelihood score threshold, assigning, by the device management circuitry, a value of a device trust score for the second user device that is equivalent to a value of the device trust score for the first user device for a limited duration.

15. The method of claim 1, further comprising:
receiving, by the communications hardware, a device identity request from a third-party device, wherein (a) the device identity request is associated with the user and an associated user device and (b) the device identity request comprises the candidate user credentials;
performing, by the verification circuitry and based on the received candidate user credentials associated with the device identity request, a verification routine for the user for the device identity request;
in an instance in which the user is successfully verified, identifying, by the device management circuitry, a device profile associated with the user account of the user for the associated user device; and
providing, by the communications hardware, a device identity confirmation response, wherein the device identity confirmation response comprises a trust score associated with the device profile.

16. The method of claim 1, further comprising:
receiving, by the communications hardware, a user evaluation request from a third-party device, wherein (a) the user evaluation request is associated with the user and a candidate user device and (b) the user evaluation request comprises the candidate user credentials;
performing, by the verification circuitry and based on the received candidate user credentials associated with the user evaluation request, a verification routine for the user for the user evaluation request;
in an instance in which the user is successfully verified, generating, by user evaluation circuitry and based on device profiles associated with the user account, a user trust score for the user, wherein the user trust score is indicative of an inferred level of security associated with the user; and
providing, by the communications hardware, a user evaluation response, wherein the user evaluation response comprises the user trust score.

17. The method of claim 16, further comprising generating, by the user evaluation circuitry and based on the user trust score, one or more product offers for a third-party institution associated with the third-party device, wherein the user evaluation response further comprises the one or more product offers.

18. The method of claim 1, wherein (a) the authorization rule set comprises one or more authorization rules and (b) the one or more authorization rules are indicative of at least one of (i) permissions of the first user device for accessing the user account, (ii) permissions of the first user device for performing actions associated with the user account, (iii) permissions of the first user device for accessing another user account, (iv) a transaction limit for the first user device, or (v) a type of user credential required to perform certain actions via the first user device.

19. An apparatus for providing a device trust dashboard, the apparatus comprising:
device management circuitry configured to:
generate a device profile for a first user device associated with a user account of a user,
determine, based on a device feature set associated with the first user device, a device trust score for the first user device,
determine, based on the device trust score and a user preference set associated with the user, an authorization rule set for the first user device, and
update the device profile for the first user device to comprise the device trust score for the first user device and the authorization rule set for the first user device;
communications hardware configured to receive a device trust dashboard request, wherein the device trust dashboard request comprises candidate user credentials; and
verification circuitry configured to perform, based on the received candidate user credentials, a verification routine for the user,
wherein the communications hardware is further configured to, in an instance in which the user is successfully verified, provide the device trust dashboard, wherein the device trust dashboard comprises at least a representation of the device profile for the first user device.

20. A computer program product for providing a device trust dashboard, the computer program product comprising at least one non-transitory computer-readable storage medium storing software instructions that, when executed, cause an apparatus to:
generate a device profile for a first user device associated with a user account of a user;
determine, based on a device feature set associated with the first user device, a device trust score for the first user device;
determine, based on the device trust score and a user preference set associated with the user, an authorization rule set for the first user device;
update the device profile for the first user device to comprise the device trust score for the first user device and the authorization rule set for the first user device;
receive a device trust dashboard request, wherein the device trust dashboard request comprises candidate user credentials;
perform, based on the received candidate user credentials, a verification routine for the user; and
in an instance in which the user is successfully verified, provide the device trust dashboard, wherein the device trust dashboard comprises at least a representation of the device profile for the first user device.
